(19) United States
(12) Patent Application Publication
(10) Pub. No.: US 2024/0028041 A1
(43) Pub. Date: Jan. 25, 2024

(54) GROUND SURFACE ESTIMATION USING DEPTH INFORMATION FOR AUTONOMOUS SYSTEMS AND APPLICATIONS

(71) Applicant: NVIDIA Corporation, Santa Clara, CA (US)

(72) Inventors: Andreas Klaus, San Jose, CA (US); Joachim Bauer, San Jose, CA (US); Joachim Pehserl, San Jose, CA (US)

(21) Appl. No.: 17/992,569

(22) Filed: Nov. 22, 2022

Related U.S. Application Data
(60) Provisional application No. 63/390,598, filed on Jul. 19, 2022.

(51) Int. Cl. G05D 1/02

(52) U.S. Cl. CPC G05D 1/0238; G05D 1/0251; G05D 1/0221; G05D 1/0219; G05D 2201/0213

(57) ABSTRACT

In various examples, a surface may be estimated using depth data for autonomous systems and applications. One or more software components or modules may use the depth data (e.g., 3D LiDAR point cloud data) in addition to ego-motion data (e.g., data representative of location, heading, speed, and/or pose of the ego-machine) to generate a non-parametric model of the ground or driving surface. In some embodiments, an iterative process may be used to generate and iteratively refine estimated surface values by minimizing (or approximating minimization of) a cost function that penalizes deviation between measured values and estimated values and/or deviations among adjacent measured values. The systems and applications described herein may include robust real-time or near real-time ground surface estimation relying on generated data, and may further include a large-scale offline ground surface estimation approach that is non-causal and uses (e.g., all) available data at once.

### CROSS-REFERENCE TO RELATED APPLICATIONS

This application claims the benefit of U.S. Provisional Application No. 63/390,598, filed on Jul. 19, 2022, the contents of which are hereby incorporated by reference in their entirety.

### BACKGROUND

The estimation of a ground surface is useful for many tasks in the field of autonomous or semi-autonomous machine control. For example, an understanding of the ground surface profile may allow for the detection of obstacles on the road surface in a robust manner, while providing an estimate of the drivable area (and thus non-drivable area) in the vicinity of the ego-machine, and serves as a guide for estimating the height of obstacles corresponding to the ego-machine's planned trajectory. However, conventional approaches to ground surface estimation often rely on finding multiple, disjoint surfaces, and trying to detect objects and/or navigate using each surface either alone or in combination. This is compute intensive, and can increase the latency of the system, as any number of different disjoint surfaces corresponding to a ground surface may be generated and/or maintained. In addition, the accuracy or precision of object detection techniques may suffer due to the requirement that object detection be separately performed for each different modeled surface—especially where a single object overlaps two or more different surfaces. As such, reconciling duplicate object detections in a post-process may be required, thus further increasing the compute and the runtime of the system. As a result, these conventional techniques to surface estimation may not be suitable, or as suitable, for real-time or near real-time deployment.

### SUMMARY

Embodiments of the present disclosure relate to ground surface estimation using depth information for autonomous systems and applications. In contrast to conventional systems, such as those described above, an iterative process may be used to generate and iteratively refine estimated surface values by minimizing (or approximating minimization of) a cost function that penalizes deviation between measured values and estimated values and/or deviations among adjacent measured values. For example, systems and methods are disclosed for estimating a model for a surface such a ground or driving surface using data generated from one or more depth sensors—such as one or more three-dimensional (3D) LiDAR sensors. The depth sensor(s) may be operated on a mobile platform—such as an autonomous or semi-autonomous machine—and may generate depth data representative of a sensory field(s) of the depth sensor(s). One or more software components or modules may use the depth data (e.g., 3D LiDAR point cloud data) in addition to ego-motion data (e.g., data representative of location, heading, speed, and/or pose of the ego-machine) to generate a non-parametric model of the ground or driving surface. The model may be represented using a regular grid that represents local height or range values, and therefore, may be used to identify local height or range variations. The systems and applications described herein may include robust real-time or near real-time ground surface estimation relying on generated data, and may further include a large-scale offline ground surface estimation approach that is non-causal and uses (e.g., all) available data at once. Prior information may be used in the form of semantic segmentation results from a trained deep neural network (DNN), in embodiments, and robust object detection based on the estimated ground surface may be performed.

### BRIEF DESCRIPTION OF THE DRAWINGS

The present systems and methods for ground surface estimation using depth information for autonomous systems and applications are described in detail below with reference to the attached drawing figures, wherein:

FIG. 1 is a data flow diagram illustrating an example surface estimation pipeline, in accordance with some embodiments of the present disclosure;

FIG. 2 is a diagram illustrating an example input generator, in accordance with some embodiments of the present disclosure;

FIG. 3 is a diagram illustrating an example surface estimator, in accordance with some embodiments of the present disclosure;

FIG. 4 is a diagram illustrating an example measurement deviation cost function and an example measurement deviation weight function, in accordance with some embodiments of the present disclosure;

FIGS. 5A and 5B are diagrams illustrating example smoothing modules, in accordance with some embodiments of the present disclosure;

FIG. 6 is a diagram illustrating an example object detection engine, in accordance with some embodiments of the present disclosure;

FIG. 7 is a flow diagram showing a method for iteratively refining an estimated surface, in accordance with some embodiments of the present disclosure;

FIG. 8 is a flow diagram showing a method for generating an estimated surface using a non-parametric model, in accordance with some embodiments of the present disclosure;

FIG. 9 is a flow diagram showing a method for iteratively smoothing estimated surface data, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

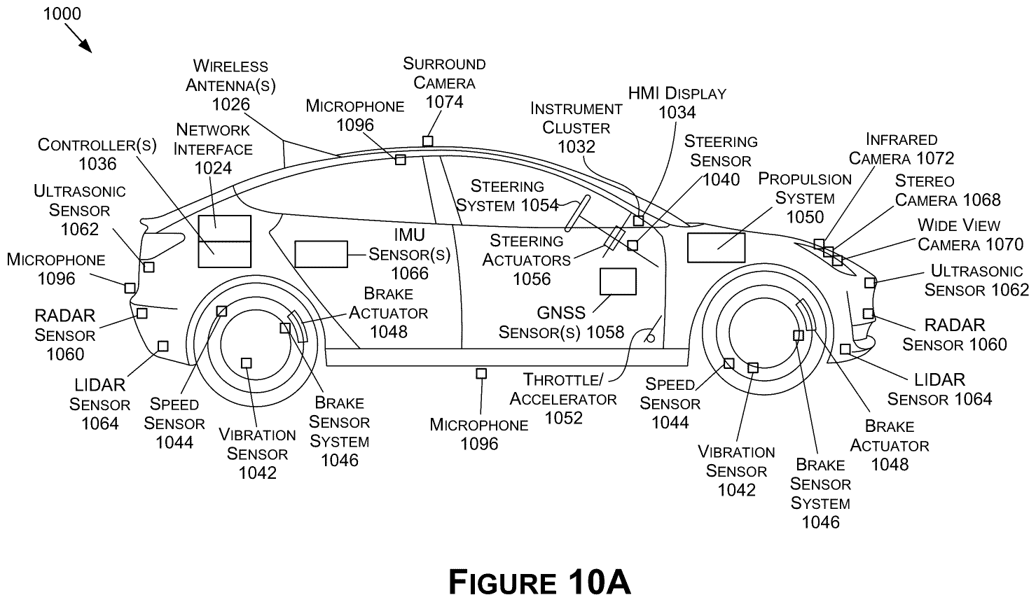

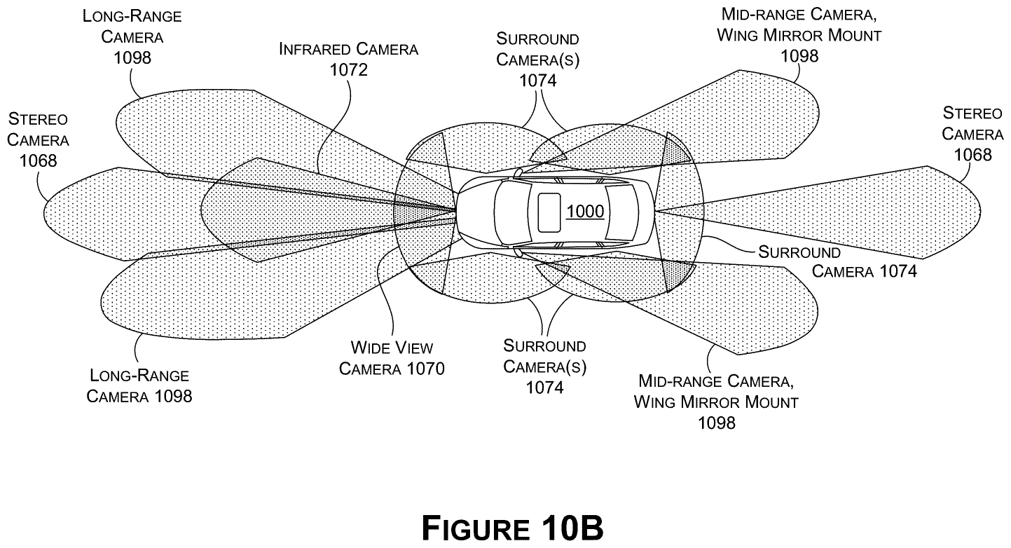

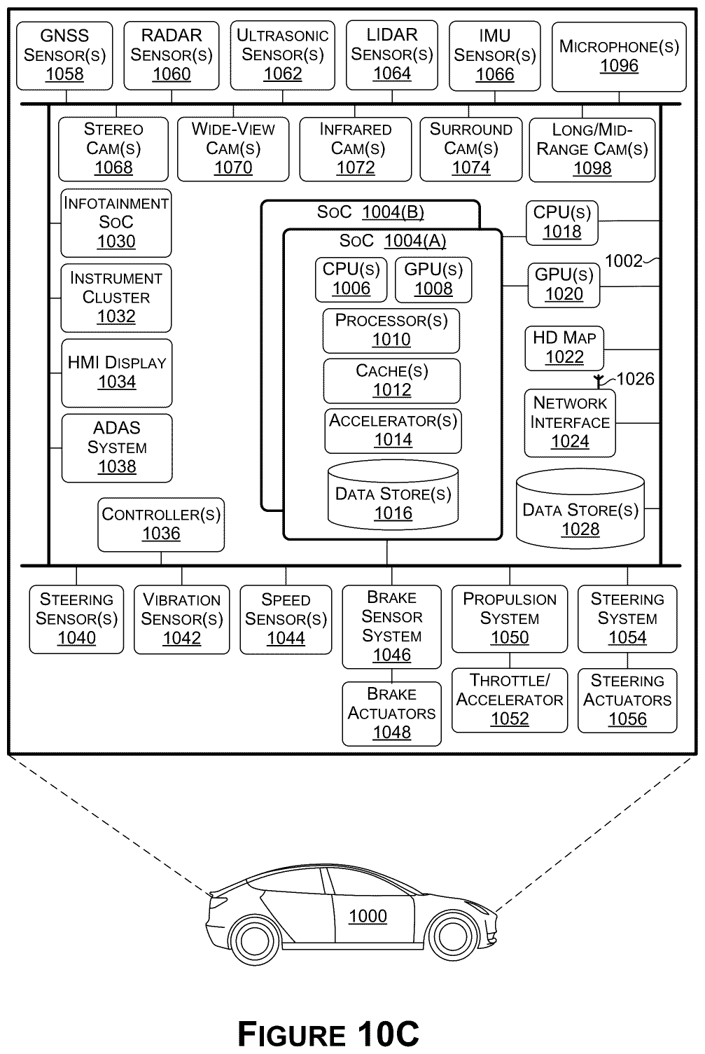

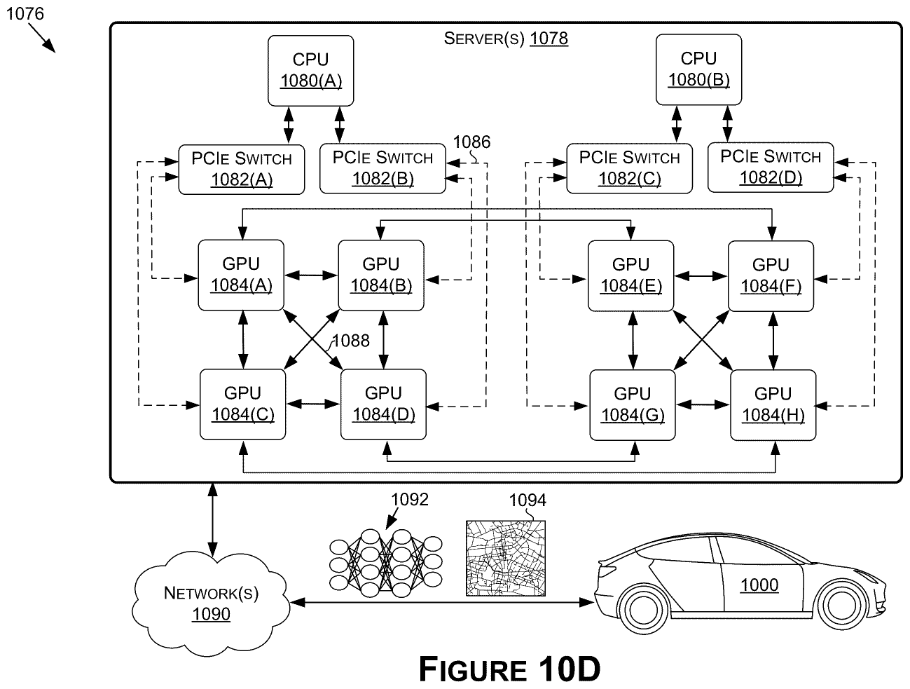

Systems and methods are disclosed related to ground surface estimation using depth information for autonomous systems and applications. Although the present disclosure may be described with respect to an example autonomous or semi-autonomous vehicle or machine 1000 (alternatively referred to herein as “vehicle 1000” or “ego-machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, trains (e.g., above or below ground), tramways, drones, and/or other vehicle types. In addition, although the present disclosure may be described with respect to ground surface estimation in autonomous machine systems and applications, this is not intended to be limiting, and the systems and methods described herein may be used in augmented reality, virtual reality, mixed reality, robotics, security and surveillance, autonomous or semi-autonomous machine applications, and/or any other technology spaces where estimating of a surface or plane—such a ground surface or plane—may be used.

Systems and methods are disclosed that model a surface such as the ground using a non-parametric model that stores a representation of an estimated surface structure (e.g., a grid of cells such as a top-down orthographic height map or a range image). Depth data generated using one or more depth sensors (e.g., LiDAR data, RADAR data, ultrasonic data, stereo camera disparity data, and/or other two-dimensional (2D) or three-dimensional (3D) sensor data) may be used to generate a corresponding projection image that represents measured 3D points (e.g., top-down height map or LiDAR range image), and the measured 3D points may be used to generate and iteratively refine estimated surface values in the model. The present techniques may be used by autonomous vehicles, semi-autonomous vehicles, robots, and/or other object or machine types to estimate a 3D surface structure of a navigable space or other component of an environment, and/or detect and avoid potential obstacles based on the estimated ground surface (e.g., based on distance between a measured 3D point and the estimated ground surface).

Overview

Generally, a particular surface, such as the ground surface, may be assumed to be a smooth and continuous surface that spans from a footprint of the ego-machine outwards. With this in mind, the systems and methods of the present disclosure may focus on estimating a single surface model, thus avoiding the ambiguities involved in finding multiple, disjoint surface models. The ground surface model may cover the same distance range as the depth (e.g., LiDAR) input data (e.g., up to 300 meters) and may provide a robust estimate for areas that are occluded by small to medium sized non-ground objects in the input data—e.g., people, vehicles, other objects above the ground surface, etc.

In various examples, systems and methods are disclosed for estimating a model for a surface such a ground or driving surface using data generated from one or more depth sensors—such as one or more three-dimensional (3D) LiDAR sensors. The depth sensor(s) may be operated on a mobile platform—such as an autonomous or semi-autonomous machine—and may generate depth data representative of a sensory field(s) of the depth sensor(s). Taking embodiments that use a LiDAR sensor as an example, the present techniques may be implemented using one or more grille-mounted, roof-mounted, forward/backward/sideward-facing LiDAR sensors, one or more 360° LiDAR sensors, and/or any combination (e.g., fused together). One or more software components or modules may use the depth data (e.g., 3D LiDAR point cloud data) in addition to ego-motion data (e.g., data representative of location, heading, speed, and/or pose of the ego-machine) to generate a non-parametric model of the ground or driving surface. The model may be represented using a regular grid that represents local height or range values, and therefore, may be used to identify local height or range variations. The systems and applications described herein may include robust real-time or near real-time ground surface estimation relying on generated data, and may further include a large-scale offline ground surface estimation approach that is non-causal and uses (e.g., all) available data at once. Prior information may be used in the form of semantic segmentation results from a trained deep neural network (DNN), in embodiments, and robust object detection based on the estimated ground surface may be performed.

Iterative Process

In some embodiments, an iterative process may be used to generate and iteratively refine estimated surface values in the model by minimizing (or approximating minimization of) a cost function that penalizes deviation between measured values and estimated values and/or deviations among adjacent measured values. For example, the 3D structure of a ground surface may be modeled using a grid of cells (e.g., an image) where each cell (or pixel) stores an estimated surface value (e.g., estimated height of a point on the surface, range to a point on the surface). Taking a grid that stores estimated height values (e.g., a top-down height map) as an example, each cell (or pixel) of the height map may store (or be associated with) an estimated height value that is iteratively refined, a measured height value (e.g., if available), a weight that emphasizes certain cells (e.g., a dynamic weight based on deviation between the measured height value and the currently estimated height value and that may be iteratively refined, a static weight based on a likelihood that the measurement is part of the ground surface and/or based on proximity to the ego-machine), a weighted measured height value (e.g., the measured height value times the weight for that cell), and/or a confidence value that quantifies confidence in the estimated height value (e.g., based on deviation between the measured height value and the currently estimated height value). As such, the height map may store (e.g., in different layers) or be associated with a grid (or map) of estimated height values, a grid (or map) of estimated height confidence values, a grid (or map) of measured height values (e.g., an orthographic or perspective projection image), a grid (or map) of cell weights, and/or a grid (or map) of weighted measured height values.

During an iterative process, each iteration may apply smoothing (e.g., averaging) to one or more of the grids, maps, or layers. In one example, Gaussian smoothing may be applied to the grid of weighted measured height values and to the grid of cells weights, and the estimated height values may be updated with a new estimated height value that results from dividing each smoothed weighted height by its corresponding smoothed weight. In another example, a red-black update scheme may be used to update estimated height values for non-adjacent cells (analogous to the white squares on a chess board), followed by updating estimated height values for the other non-adjacent cells (analogous to the black squares on the chess board), where the estimated height value for each cell may be computed by minimizing a cost function, performing an average (e.g., arithmetic, weighted average) of the height measurements of its adjacent cells, and/or otherwise. Depending on the embodiment, the iterative process may run for a fixed number of iterations, or may terminate based on some termination criteria (e.g., maximum slant of the estimated ground surface is less than a known maximum slant from a local map, a particular slant of the estimated ground surface is less than an estimated surface normal corresponding to the ego-motion of the ego-machine, maximum number of iterations, goodness of fit (e.g., relative improvement over successive iterations), maximum local update is less than a threshold). In some embodiments, the iterative process may skip updating regions where estimated heights have already converged (e.g., within a threshold) and proceed to updating the remaining areas. In some embodiments, to reduce processing time, one or more of the grids, maps, or layers may be converted into a corresponding image pyramid, and the iterative process may be used to iteratively refine the coarsest level of the image pyramid(s), which may be up-sampled, iteratively refined, up-sampled, and so on.

Grid and Projection Image

In some embodiments that estimate a ground surface, the grid(s) may be any suitable size (e.g., 800×200 cells) and may use any suitable ground sampling size (e.g., 10 cm/cell, 1 m/cell), for example, depending on the desired coverage of the ground surface and/or the driving scenario. In some highway scenarios (e.g., Level 3 highway driving), the coverage area may extend 200 or 300 meters in front of the ego-machine, while in some urban scenarios (e.g., Level 4 robotaxi driving), the desired coverage area may be less. In some embodiments, the ground sampling size may be controlled via an external control signal that changes the ground sampling size (e.g., based on the driving scenario). Additionally or alternatively, ground sampling size may be controlled based on velocity of the ego-machine, slant of the estimated surface, and/or other factors. In an example involving slant-based control, a slant value may be derived from the estimated ground surface from a preceding time slice (e.g., a maximum slant value in a local region of the estimated surface such as below the ego-machine or some distance in front of the ego-machine), and ground sampling size may decrease with increasing slant values and vice versa (e.g., use 10 cm/cell at larger slant values and increase ground sampling size on flatter terrain such as a flat highway).

In some embodiments, the grid(s) may use a decreasing resolution (e.g., a logarithmically or quadratically decreasing spatial resolution). By way of motivation, consider a highway scenario with an ego-machine equipped with a LiDAR sensor that can detect a 3D point 300 meters away. Higher granularity may be desired in the near or medium field than in the far field where measured 3D points are sparser. As such, some embodiments, use a ground sampling size that depends on distance from the ego-machine, distance from an axis of a corresponding rig coordinate system, row of cells of the grid(s), and/or the like. For example, ground sampling size may increase linearly, logarithmically, using some discrete or continuous mapping function, and/or otherwise. In one example, the first 10 rows of grid cells (e.g., in front of the ego-machine) may use a first ground sampling size (e.g., 10 cm/cell), the next 10 rows of grid pixels may use a second ground sampling size (e.g., 20 cm/cell), and so on. In some embodiments, the grid(s) represent an orthographic (e.g., top-down) view that maps an angle (e.g., azimuth angle) to one dimension of the grid (e.g., the x-axis) and maps range (e.g., Euclidean distance) to another dimension (e.g., the y-axis), and the dimension that represents range may use a decreasing spatial resolution. These are just a few examples, and other variations are contemplated within the scope of the present disclosure.

Generating a Projection Image

The surface estimation technique described herein may be used in a variety of scenarios, including real-time (or near real-time) ground surface estimation relying on observed depth data, a large-scale offline ground surface estimation approach that is non-causal and uses (e.g., all) available data at once, and/or other scenarios. For example, a 3D surface structure such as the 3D surface structure of a navigable space (e.g., a drivable space such as a road surface) may be observed and estimated to generate a 3D point cloud, a range image, or other representation of the 3D surface structure. In some embodiments involving a real-time (or near real-time) deployment using one or more sweeping or spinning depth sensors such as LiDAR and/or RADAR sensor(s), the last N spins worth of depth data (e.g., 3D point clouds) may be combined (e.g., accumulated and ego-motion compensated) and processed in real-time (e.g., collected and processed at each time slice). In some embodiments in which there is more processing time and memory available, some larger number of spins worth of depth data (e.g., 3D point clouds) may be combined and processed.

For some types of depth data (e.g., a 3D point cloud captured during a sweep or spin of a LiDAR or RADAR sensor), there is some time between capturing the first point and last point in a sweep. As such, ego-motion compensation may be used to shift the 3D locations of the data points to a common timestamp, so the points in the point cloud have locations that correspond to where those points would have been if they were captured at the same time. In some embodiments (e.g., real-time), the most recent N spins worth of 3D points (e.g., the most recent N point clouds) may be combined into a common time frame, for example, by taking the previous N−1 spins (and their transformation chains from spin to spin) and projecting each point into the time frame of the most recent spin using the applicable ego-motion for each point. In some offline embodiments, any number of spins may be collected (e.g., by a survey car while driving around an entire city block), and the point clouds captured by some or all the spins may be ego-motion compensated to generate a combined representation of the 3D environment (e.g., a 3D point cloud representing the city block). As such, whether running in real-time on some number of LiDAR (or RADAR) spins, or running on a larger dataset (e.g., collected by a survey car or aerial LiDAR sensor) in a scenario where more run time and memory are available, depth data may be accumulated and/or ego-motion compensated into a combined representation of the 3D environment (e.g., a 3D point cloud).

In some embodiments, each measured 3D point is classified (e.g., as being part of a vehicle, navigable surface, lane line, Botts' dot, etc.) using any known classification technique (e.g., neural network, random forest, manually or automatically labeling), and measured 3D points that are determined not to be part of the ground surface may be removed or down-weighted (e.g., using a predicted confidence value representing a likelihood that the point is part of the ground surface). In an example embodiment, a DNN may be used to semantically segment a perspective image into a semantic segmentation image, each measured 3D point may be backprojected into the semantic segmentation image, and the projected 3D points that land on pixels that not classified as part of the ground surface may be removed. Additionally or alternatively, each measured 3D point may be assigned a weight corresponding to the predicted confidence value indicating the likelihood that a corresponding pixel is part of the ground surface (e.g., navigable surface, lane line, Botts' dot), and the weights may be used to prioritize measurements that are predicted to be part of the ground surface, as explained in more detail below.

In some embodiments, collected, measured, accumulated, ego-motion compensated, filtered, and/or otherwise generated depth data may be processed into a format (e.g., an orthographic or perspective projection image) that corresponds with the model of the surface being estimated. For example, if the model of the surface is a top-down height map, depth data (e.g., a 3D point cloud) may be orthographically projected into top-town projection image (a height map) with corresponding dimensions. If the model of the surface is a range image, the depth data may be projected into a perspective image (a range image) with corresponding dimensions. Depending on the scenario, any particular pixel (or cell) of the projection image may correspond to one measured 3D point, multiple measured 3D points, or no measured 3D points. In some embodiments in which multiple measured 3D points land on a particular pixel (e.g., which may occur for pixels that represent locations that are relatively closer to a sensor), the measured 3D point with the lowest height (or farthest range) may be associated with the pixel (e.g., the pixel may store that point's measured height or range value). In some embodiments in which no measured 3D point lands on a particular pixel, that pixel may assigned a height or range value (and a corresponding weight value) of zero. Additionally or alternatively, a local ground surface estimation map may be maintained over multiple time slices (e.g., projecting each point cloud into the map and filling in gaps in the map with measurements for newly observed areas). As such, in some embodiments in which no measured 3D point lands on a particular pixel, a corresponding portion of the local ground surface estimation map may be looked up to determine whether the region corresponding to that particular pixel was previously observed, and if so, that value (e.g., a height or range value for a region of the ground surface that is currently occluded but was previously observed) may be retrieved and stored by the pixel. As such, a projection image representing measured values (a measured height map or measured range image) may be generated.

Initializing an Estimated Surface Model

In some embodiments, an estimated surface model (e.g., a top-down estimated height map, an estimated range image) may be initialized, for example, to ensure (or target) a robust convergence to a globally optimized solution. Depending on the application, a current ego-motion estimate may be used to derive an estimate of the ground surface in the immediate vicinity of the ego-machine. This may be performed using known calibration data to compute the height of the depth sensor above the ground plane or surface, and, therefore, to initialize an estimated ground surface in the vicinity of the ego-machine based on the surface normal represented by the direction of ego-motion. Additionally or alternatively, historic surface estimations from previous time slices may be maintained and used to use this prior information to robustly set initial values for an estimated ground surface for a current time slice. Historic surface estimations may be represented by a local ground surface estimation map, which may include features that are influenced by, e.g., vehicle dynamics. For example, in some embodiments, a local ground surface estimation map may be maintained over multiple time slices, may be retained for a longer period of time in case of low ego-velocity or complete standstills, and/or may be maintained over larger regions at higher ego-velocities. As such, in some embodiments, previously populated values in a local ground surface estimation map may be used to initialize values in an estimated surface map (e.g., a top-down estimated height map, an estimated range image). Additionally or alternatively, measured values may be used to initialize values in an estimated surface map (e.g., prioritizing previously populated values in the local ground surface estimation map, if available).

Initializing Weights

Depending on the embodiments, weight may be initialized in various ways. In some embodiments (e.g., in which weights serve to emphasize certain measured values), a weight map may be initialized with dimensions that correspond to the generated projection image and initialized estimated surface model. In some embodiments (e.g., at time slice), each pixel (or cell) in the weight map is assigned one or more corresponding weights. Example weights include a measurement deviation weight that penalizes pixels that carry measurements that deviate from a current (or initialized) estimated surface value for that cell (e.g., based on the difference between a measured height or range value and a currently estimated height or range value), a classification weight based on likelihood that the measured 3D point represented by the pixel is part of the ground surface (e.g., a predicted confidence value, as described above), a proximity weight based on proximity to the ego-machine (e.g., assign a higher weight to pixels representing locations near the ego-machine such as locations within a meter or two radius, as the ground may be known to be some distance such as half a meter below a particular sensor, the ground surface in the vicinity of the ego-machine may be assumed to be relatively flat, and pixels representing these locations may be more likely to be ground cells), and/or other weights.

In an example embodiment, a weight map (or grid) is initialized with (e.g., predicted) confidence values representing likelihoods that the measured 3D points represented by pixels (or cells) that carry measured values are part of the ground, and zeros for pixels (or cells) that do not carry measured values. Additionally or alternatively, a weight map may be initialized with any combination of different types of weights (e.g., combined by multiplication). In some embodiments, a weighted measured height map may be initialized by multiplying the measured height value by the weight for each pixel (or cell).

In some embodiments, a measurement deviation weight is determined using a measurement deviation cost (and/or weight) function, such as an asymmetric deviation cost function. Taking a height map as an example, some embodiments seek to avoid or minimize measured points that lie above the ground from impacting the estimated ground height. As such, a cost (and/or corresponding weight) may be assigned based on the deviation between a measured height (or range) and an estimated height (or range). For example, some embodiments define an asymmetric deviation cost function that penalizes measured 3D points that lie above the ground surface differently than measured 3D points that lie below it (e.g., using a fixed cost above a threshold distance above the ground). In some embodiments, given a designated measurement deviation cost (and/or weight) function and its derivative, a measurement deviation weight function may be defined as the derivative of the cost function divided by deviation (e.g., the difference between the height measurement and the current estimated height). As such, given a measured height (or range) value and a current estimated height (or range) value, a cost or weight function may be evaluated to assign a measurement deviation weight to a corresponding cell in a weight map.

Iterative Smoothing

In some embodiments, smoothing may be iteratively applied to one or more of the maps, grids, or layers of (or associated with) the estimated surface model. In some embodiments, a weighted convolution may be applied, for example, using a filtering operation (e.g., Gaussian smoothing) performed by sliding a (e.g., Gaussian) kernel across one or more (e.g., two) maps (e.g., the weighted measured height map and optionally the weight map) to smooth the map(s). This approach expands the area of influence (similar to the large receptive fields achievable in DNNs) and increases the robustness of the method by avoiding the entrapment of the solution in local minima. The window size of the filter kernel may be, for example and without limitation, 9×9, and the standard deviation may lie in the range [1 . . . 3]. Consequently, each filter-based smoothing iteration may consider, for example, the 80 neighbors in a local 9×9 window. In an example embodiment, a first iteration may involve applying Gaussian smoothing, and then updating each estimated height value with a new estimated height value that results from dividing each smoothed weighted measured height by its corresponding (smoothed) weight. Since the estimated height values and/or weights may have changed, subsequent iterations may involve re-computing a weight map (e.g., in embodiments that use measurement deviation weight), then applying Gaussian smoothing and updating estimated height values. The process may repeat for any number of iterations.

In some embodiments, the smoothing applied in each iteration involves execution of a red-black update scheme to update estimated height values for non-adjacent cells (analogous to the white squares on a chess board), followed by updating estimated height values for the other non-adjacent cells (analogous to the black squares on the chess board), where the estimated height value for each cell may be computed by minimizing a cost function, performing a weighted average of the height measurements of its adjacent cells (e.g., if available), and/or otherwise. In some embodiments, for each cell in the estimated height map, a height value that minimizes a cost function (e.g., an asymmetric cost function, a composition of cost functions) may be calculated and assigned to the cell. In embodiments in which the cost function is a composition of multiple cost functions, the estimated height value for a particular grid cell may be updated by identifying candidate height values that minimize each of the cost functions, calculating the corresponding cost of each candidate height value, and selecting the candidate height that produced the minimum cost as the estimated height value for that cell. In some embodiments in which the cost function is a composition of multiple cost functions, instead of minimizing each of the costs functions, the applicable cost function for the range of height deviations that includes the current estimated height value may be selected and minimized to calculate the estimated height value for that cell. In some embodiments that compute a weighted average using a fixed smoothing weight for each of the contributing neighbors, adjacent cells are only included in the weighted sum if they have a measurement in them (or if the cell is empty, a smoothness weight of zero may be applied). Since each height value for a white cell depends on only adjacent black cells, and vice versa, this technique is highly parallelizable, and reduces computation time over techniques.

Image Pyramid

In some embodiments, in order to increase the rate of convergence, a hierarchical approach may be applied. This approach may build (e.g., for each map) a pyramid of, e.g., five levels with decreasing spatial resolution (e.g., using a reduction factor of two). Optimization may begin at the highest pyramid level (the coarsest level with the lowest resolution), and after iteratively refining that level (of maps), the map(s) from the higher pyramid level may be propagated down to the next level by up-sampling. The up-sampling may be based on bilinear interpolation, a nearest neighbor approach (e.g., taking one data value at the higher level to initialize four corresponding values at the lower level, which is motivated by the smooth nature of the solution and results in a runtime improvement), and/or otherwise. In some embodiments that use a measurement deviation weight that relies on a composition of cost or weight functions separated at a threshold deviation (a threshold difference between measured and estimated height values), the threshold may be larger in upper pyramid levels to address the higher uncertainty of the solution in these levels. More specifically, since ground sampling size is larger in the upper (coarser) pyramid levels, there is more uncertainty in the model's accuracy because measurements may be assumed to represent the center of a grid cell when they actually represent the edge of a grid cell. Assuming a particular slant in the ground surface, this uncertainty is larger for larger ground sampling sizes. To compensate for this larger uncertainty, some embodiments use a larger threshold in the cost/weight function for upper (coarser) pyramid levels than in lower ones.

Post-Processing

In some embodiments, the final solution (e.g., an estimated surface) may be verified in a post-processing operation(s) (e.g., for each time slice). During this verification process, application specific and/or scenario specific constraints may be enforced. A non-limiting example of a constraint includes maximal slant values of the ground (e.g., for highway versus urban scenarios). During post-processing, a confidence value may be assigned to each grid cell. The confidence value may be based on a-posteriori weights after a completed iteration, after all the last iterations, and/or otherwise. This confidence value may reflect the agreement between the solution and the input data, and thus the confidence value may be high when many measured 3D (e.g., LiDAR) points in a local neighborhood are close to the final solution. As such, an estimated surface model may be generated with estimated height (or range) values and corresponding confidence values.

Object Detection Use Cases

An estimated surface model (also referred to as an estimated surface) may be used in various ways. In some embodiments, an estimated surface may be used as, or used to derive, a 3D structure for a navigable space (e.g., a road). For example, in the process of generating an estimated surface, points that are classified as not being part of a navigable space may be filtered out from a measured height map or de-emphasized prior to surface estimation, so the resulting estimated surface may be assumed to be an estimation of the navigable space. Additionally or alternatively, free space estimation may be applied to a captured image to detect pixels that belong to a navigable space (e.g., drivable free-space), corresponding classified 3D locations may be assigned to pixels that were classified as being part of the navigable space using any known technique (e.g., to backproject pixels from the image into a 3D coordinate system), and 3D points on the estimated surface that fall within some threshold distance (e.g., threshold height or range) of the classified 3D locations that were classified as part of the navigable space may be selected (and the others filtered out). As such, 3D points of the estimated surface may be determined to belong to a navigable space (e.g., drivable free-space), for example, based on the 3D point falling within some threshold distance to a classified 3D location. Accordingly, the 3D points on the estimated surface determined to be part of the navigable space (e.g., the road) may be used to generate any suitable representation of the 3D surface structure of the navigable space, such as a 3D point cloud. As such, the techniques described herein may be used to observe and reconstruct a representation of a navigable space (e.g., drivable free-space), such as a 3D road surface, and the representation of the navigable space (and/or corresponding confidence values) may be provided to an autonomous or semi-autonomous vehicle's drive stack to enable safe and comfortable planning and control of the vehicle. In some embodiments, a representation of road may be combined with corresponding measured intensity values (e.g., a multi-channel image or tensor storing projected measured 3D road surface values in one channel and one or more corresponding radiometric properties in other channel(s) such as intensity values in an intensity channel) and may be processed with one or more neural networks to identify (e.g., classify) road marks such as cross-walks, guiding stripes, and/or others, and the identified road marks may be used to facilitate localization, path planning, and/or other uses.

In another example use of an estimated surface, knowing which 3D points belong to the ground surface and therefore do not belong to obstacles, measured 3D (e.g., LiDAR) points that correspond to those 3D points may be filtered out and the remaining measured 3D points may be classified using any known technique to detect obstacles and/or other objects represented by the measured 3D points. By removing measured 3D points that belong to the ground surface prior to classification, the number of 3D points that are processed by an object detection algorithm may be reduced.

One example of a potential type of object detection is a determination that measured 3D (e.g., LiDAR) points belong to an object that is sufficiently high above an estimated surface such that that an ego-machine may safely navigate under the object (a determination of under-drivability). More specifically, measured 3D points that are greater than (or equal) some threshold height above an estimated ground surface may be classified as belonging to an object(s) that the ego-machine may safely pass under. In some embodiments, measured 3D points that are (at or) above than the threshold height above the estimated ground surface may be removed from subsequent processing and/or disregarded from further object detection analysis. By removing measured 3D points (at or) above a threshold height above the estimated ground surface prior to (subsequent) classification, the number of 3D points that are processed by an object detection algorithm may be reduced. In embodiments that combine removal of measured 3D points (at or) above a threshold height with removal of measured 3D points that belong to the ground surface, the number of measured 3D points processed by a subsequent object detection algorithm may be reduced by approximately 55% for urban scenarios and 65% for highway scenarios, as compared to conventional systems, substantially reducing computational demands and speeding up processing times.

Another example of a potential type of object detection is a determination that measured 3D (e.g., LiDAR) points belong to an object that is sufficiently low on an estimated surface such that the ego-machine may safely navigate over the object (a determination of over-drivability). More specifically, in some embodiments, measured 3D points that are determined not to be part of the ground surface (e.g., based on corresponding measured 3D points that belong to the ground surface being removed prior to classification) may be classified as part of a road hazard or obstacle and its height may be estimated by comparison to the estimated ground surface. Measured 3D points that are less than (or equal to) some threshold height above the estimated ground surface and/or (equal to or) smaller than some threshold size may be classified as belonging to a small object that can be safely driven over.

In some embodiments (e.g., that filter out or classify measured 3D points that belong to a navigable space, measured 3D points that may be safely driven under, and/or measured 3D points that may be safely driven under), remaining 3D points may be classified as belonging to obstacles (e.g., objects that are on or sticking out of the ground surface, suspended objects that the ego-machine cannot safely pass under) that may need avoidance regardless of class type (e.g., avoid all remaining objects, avoid objects larger than a designated size). In some embodiments, a representation of some or all detected objects or obstacles may be provided to a tracking system or application as a pre-tracking step to initialize object tracking (e.g., whether putative obstacles are static or moving).

As such, a representation of one or more detected objects (e.g., a navigable space and/or one or more detected obstacles) generated using the present techniques may enable improved navigation, safety, and comfort in autonomous driving. For example, an autonomous vehicle may be better equipped to navigate through a detected navigable space, avoid obstacles, adapt the vehicle's suspension system to match the current road surface (e.g., by compensating for bumps in the road), to navigate the vehicle to avoid protuberances (e.g., dips, holes) in the road, and/or to apply an early acceleration or deceleration based on an approaching surface slope in the road. Any of these functions may serve to enhance safety, improve the longevity of the vehicle, improve energy-efficiency, and/or provide a smooth driving experience.

Example Ground Surface Estimation Technique

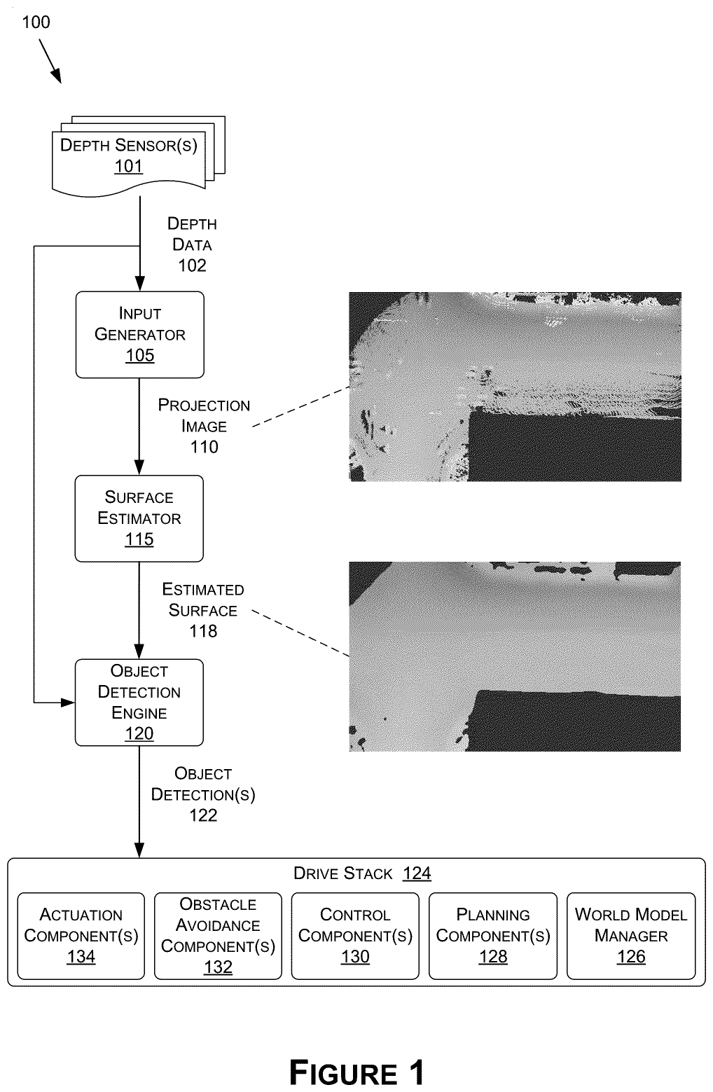

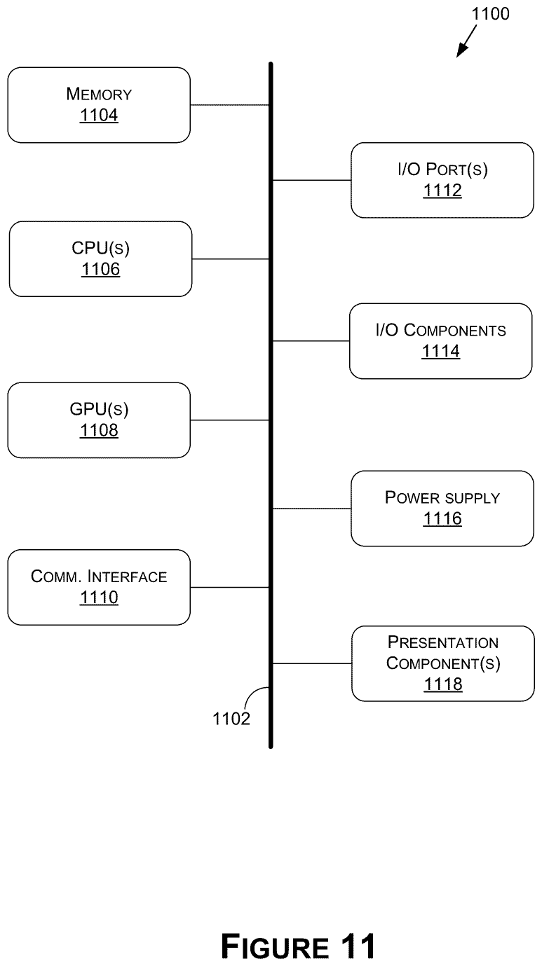

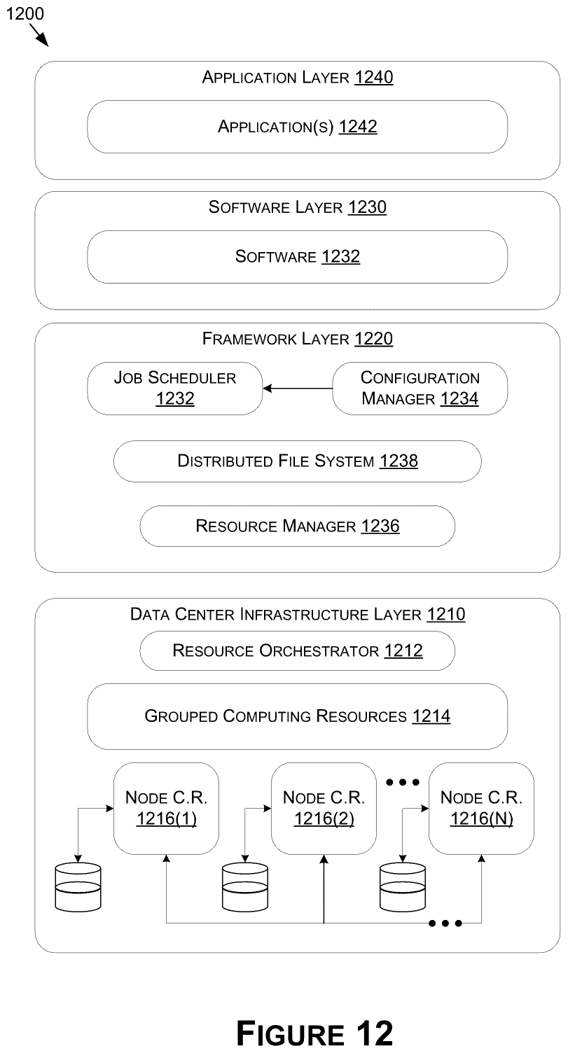

FIG. 1 is a data flow diagram illustrating an example surface estimation pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

At a high level, the surface estimation pipeline 100 may estimate and generate a representation of an observed 3D surface structure (e.g., an estimated surface 118), such as that of a 3D road surface or other environmental part, based on depth data 102 representing a three-dimensional (3D) environment. The depth data 102 may be captured by one or more depth sensor(s) 101 of an ego-machine (e.g., autonomous vehicle 1000 of FIGS. 10A-10D, also referred to as the vehicle 1000) as the ego-machine navigates through the 3D environment. An input generator 105 may process the depth data 102 to generate a representation of an observed portion of the 3D environment (e.g., a projection image 110), which may comprise a projected 2D representation of measured 3D points on a 3D surface structure of interest (e.g., a projected 3D point cloud). FIG. 1 is illustrated with an example of a possible projection image 110, more specifically, a top-down orthographic projection of LiDAR points from a LiDAR point cloud representing a driving surface and/or any objects/obstacles on the driving surface, where pixels store height values that are represented in FIG. 1 as different greyscales. A surface estimator 115 may generate and iteratively refine an estimated representation of the observed 3D surface structure (e.g., the estimated surface 118) based on ego-motion of the ego-machine, measured 3D points from a current time slice (e.g., the projection image 110), measured 3D points from a previous time slice, and/or other factors. FIG. 1 is illustrated with an example of a possible representation of an estimated surface 118 corresponding to the projection image 110, more specifically, a top-down representation of the driving surface represented by the projection image 110.

In some embodiments, an object detection engine 120 generates object detection(s) 122 based on the depth data 102 and/or the estimated surface 118. As such, the estimated surface 118 (or other representation of the observed 3D surface structure) and/or the object detection(s) 122 may be provided to, and used by, control component(s) of the ego-machine (e.g., an autonomous driving software stack 124 and/or components of the autonomous vehicle 1000 of FIGS. 10A-10D such as controller(s) 1036, advanced driver assistance system (ADAS) system 1038, and/or SOC(s) 1004) to aid the ego-machine in performing one or more operations within the 3D environment, such as path planning, obstacle or protuberance avoidance, object tracking, adapting a suspension system of the ego-machine to match the current road surface, applying an early acceleration or deceleration based on an approaching surface slope, mapping, and/or others.

Generally, surface estimation and/or 3D surface reconstruction may be performed using depth data 102 from any number and any type of depth sensor (e.g., the depth sensor(s) 101), such as those described with respect to the autonomous vehicle 1000 of FIGS. 10A-10D. For example, the depth sensor(s) 101 may include one or more sensors of an ego-machine, such as one or more LiDAR sensor(s) (e.g., the LIDAR sensor(s) 1064 of the vehicle 1000), RADAR sensor(s) (e.g., the RADAR sensor(s) 1060 of the vehicle 1000), ultrasonic sensor(s) (e.g., the ultrasonic sensor(s) 1062 of the vehicle 1000), stereo camera(s) (e.g., the stereo camera(s) 1068 of the vehicle 1000), other camera(s) (e.g., the wide-view camera(s) 1070 (e.g., fisheye cameras), infrared camera(s) 1072, surround camera(s) 1074 (e.g., 360 degree cameras), long-range and/or mid-range camera(s) 1098 of the vehicle 1000), and/or other 2D or 3D sensor(s). In some embodiments, the depth data 102 is generated using Structure from Motion (SfM), stereo vision, and/or some other 3D estimation technique. SfM and stereo vision are ranging techniques that estimate 3D structure from multiple images. SfM estimates 3D structure from sequences of images (e.g., captured by the same camera), while stereo vision estimates 3D structure from multiple images captured at substantially the same time from different perspectives (e.g., by different cameras). In some embodiments, image rectification, de-warping. and/or distortion correction may be applied to prior to estimating depth. In some embodiments where multiple sensors are used, the sensors may view a common region of the 3D environment with an overlapping portion of their respective fields of view such that the depth data 102 from different sensors represents the common region. As such, the sensor(s) 101 may be used to generate depth data 102 that represents measured 3D points in the 3D environment around the ego-machine.

In some embodiments, the input generator 105 generates a representation of an observed portion of the 3D environment (e.g., projection image 110) based on the depth data 102. For example, the input generator 105 may generate a 2D representation of measured 3D points represented by the depth data 102 by projecting the measured 3D points into a 2D view (e.g., a projection image 110) that represents the measured 3D points (e.g., a top-down height map or LiDAR range image). In some embodiments, the input generator 105 uses a segmentation mask or other classification data to select measured 3D points that are on a desired surface, such as road surface (e.g., by overlaying the classification data on the depth data 102), and project only those selected 3D points into the projection image 110. Additionally or alternatively, the input generator 105 may accumulate and/or ego-motion compensate the depth data 102 over multiple time slices (e.g., multiple LiDAR spins), and project the accumulated and/or ego-motion compensated depth data into the projection image 110. As such, the input generator 105 may generate a representation of an observed portion of the 3D environment and/or measured 3D points on a 3D surface structure of interest (e.g., a projected 3D point cloud).

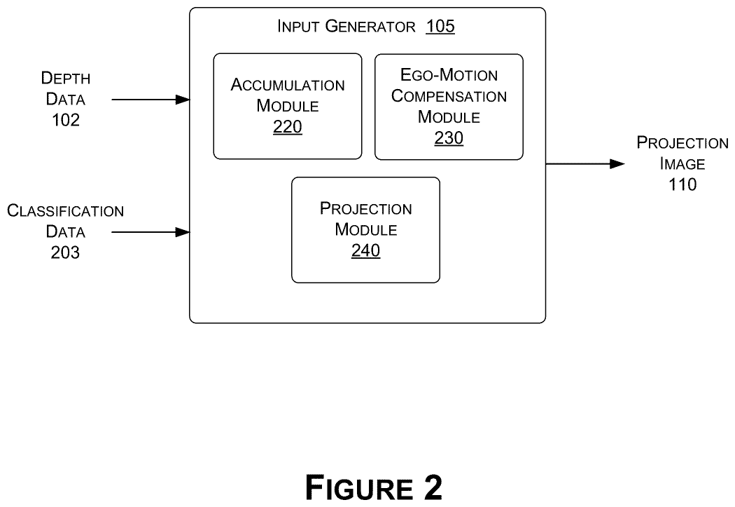

FIG. 2 is a diagram illustrating an example implementation of the input generator 105 of FIG. 1, in accordance with some embodiments of the present disclosure. In FIG. 2, the input generator 105 generates a projection image 110 that represents measured 3D points (e.g., a top-down height map or LiDAR range image) represented in the depth data 102.

Based on the use case, the data interface used to generate or access the applicable depth data 102 for the projection image 110 may differ. For example, in some embodiments involving real-time or near real-time deployment in an ego-machine (e.g., the vehicle 1000), the data interface may include a 3D LiDAR point cloud from one or multiple LiDAR sweeps, calibration data that relates a laser scanner coordinate system of a particular LiDAR sensor to those of the ego-machine, and a 6 degree-of-freedom (DOF) ego-motion estimate for the ego-machine. In some embodiments, the input generator 105 (or some other upstream component included or associated with the applicable sensor) may align LiDAR points with respect to a local Cartesian coordinate system where, for example, the direction of gravity corresponds to the negative z-axis (and the up-direction is in positive z-direction), the remaining coordinate axes may be arbitrary and may be defined by the local coordinate system of the sensor platform (e.g., a sensor rig). With this setup, the alignment operation may be left to the input generator 105. In some embodiments involving large-scale offline ground surface estimation, the depth data 102 may include a 3D LiDAR point cloud, and the input generator 105 may align the 3D LiDAR point cloud to a local Cartesian coordinate system, where the up-direction is the positive z-axis. These are just a few examples, and other ways of capturing and/or representing depth data are contemplated within the scope of the present disclosure.

In the example illustrated in FIG. 2, the input generator 105 includes an accumulation module 220, an ego-motion compensation module 230, and a projection module 240. In some embodiments involving a real-time (or near real-time) deployment, the accumulation module 220 accumulates the last N time slices' worth of depth data 102 (e.g., 3D point clouds). In some embodiments, whether or not involving a real-time (or near real-time) deployment, the ego-motion compensation module 230 ego-motion compensates measured 3D points represented by the depth data 102 into a common time slice (e.g., timestamp). The projection module 240 projects the (accumulated, ego-motion compensated) measured 3D points into the projection image 110.

In some embodiments, the accumulation module 220 accumulates the depth data 102 (e.g., over time, from multiple sensors with different locations/orientations on an ego-machine) and/or transforms the depth data 102 to a single coordinate system (e.g., a rig coordinate system centered around the ego-machine). The accumulation module 220 may accumulate the depth data 102 over time (e.g., the last N time slices' worth of depth data, such as the last N spins' worth of measured 3D point clouds) in order to increase the density of the accumulated depth data. The depth data 102 may be accumulated over any desired window of time (e.g., 0.5 seconds (s), 1 s, 2 s, etc.). The size of the window may be selected based on the sensor and/or application (e.g., smaller windows may be selected for noisy and/or fast-driving applications such as highway scenarios). As such, the projection image 110 for each time slice may be generated from accumulated detections from each window of time from a rolling window (e.g., from a duration spanning from t-window size to present). Each window to evaluate may be incremented by any suitable step size, which may but need not correspond to the window size. Thus, each successive projection image 110 may be based on successive windows, which may but need not be overlapping.

In some embodiments, the ego-motion compensation module 230 applies ego-motion compensation to the depth data 102 (e.g., 3D LiDAR points, 3D RADAR points, ultrasonic data, a sequence or time-series of images captured over time). For example, the ego-motion compensation module 230 may ego-motion-compensate a measured 3D point to the latest known ego-motion position. 3D locations of older detections may be propagated to correspond to a latest known position of a moving ego-machine, using the known motion of the ego-machine to estimate where the older detections will be located (e.g., relative to the present location of the ego-machine) at a desired point in time (e.g., the current point in time). The result may be a set of accumulated, ego-motion compensated depth data 102 (e.g., a 3D point cloud) for a particular time slice.

In some embodiments, the input generator 105 uses classification data 203 that represents whether each measured 3D point is part of the surface being estimated (e.g., the ground surface) to identify and remove measured 3D points that are not (classified as) part of the surface. For example, each measured 3D point may be classified (e.g., as being part of a vehicle, navigable surface, lane line, Botts' dot, etc.) using any known classification technique (e.g., neural network, random forest, manually or automatically labeling), and the input generator 105 may remove measured 3D points that are determined not to be part of the ground surface being estimated (e.g., based on a predicted confidence value representing a likelihood that a particular measured 3D point is part of the ground surface being less than a threshold confidence level). In an example embodiment, a DNN may be used to semantically segment a perspective image to generate the classification data 203 (e.g., a semantic segmentation image, predicted confidence levels, etc.). As such, the input generator 105 may backproject measured 3D points represented in the depth data 102 into the semantic segmentation image, and the input generator 105 may remove projected 3D points that land on pixels that are not classified as part of the ground surface (e.g., prior to accumulation, ego-motion compensation, or projection into the projection image 110).

In some embodiments, the projection module 240 projects the (e.g., accumulated, ego-motion-compensated, and/or filtered) depth data 102 to form a 2D representation of measured 3D points represented by the depth data 102 (e.g., the projection image 110) of a desired size (e.g., spatial dimension), such as an orthographic projection (e.g., a height map with a top-down view) or a perspective projection (e.g., a range image with a perspective view). In some embodiments that use a perspective projection, any suitable perspective projection may be used (e.g., spherical, cylindrical, pinhole, etc.). In some cases, the type of projection may depend on the type of sensor. By way of non-limiting example, for spinning sensors, a spherical or cylindrical projection may be used. In some embodiments, for a time-of-flight camera (e.g., Flash-LiDAR), a pinhole projection may be used. Generally, the 2D representation of measured 3D points represented by the depth data 102 may be understood as a projection image, a measurement map, a grid of measured values, and/or data representing the depth data 102 from a particular 2D view. In FIG. 2, the 2D representation is referred to as the projection image 110.

To facilitate efficient processing, the projection image 110 may include a regularly spaced grid (e.g., a grid with rows and columns of cells of the same size, e.g., pixels). This may allow for the use of optimized algorithms, similar to those used in image processing. In some embodiments, the grid may be any suitable size (e.g., 800×200 cells) and may use any suitable sampling size (e.g., 10 cm/cell, 1 m/cell), for example, depending on the desired coverage of the surface and/or a driving scenario. In some embodiments, the surface (e.g., ground) sampling size may be controlled via an external control signal that changes the surface sampling size (e.g., based on the driving scenario). Additionally or alternatively, a surface sampling size may be controlled based on velocity of the ego-machine, slant of the estimated surface, and/or other factors. In some embodiments, the grid may use a logarithmically or quadratically decreasing spatial resolution. As such, depending on the implementation and/or scenario, the projection module 240 may determine the applicable grid size and/or surface sampling size, and may generate the projection image 110 using the applicable grid size and surface sampling size.

More specifically, the projection module 240 may identify the applicable (e.g., accumulated, ego-motion compensated, filtered) measured 3D points, and may map each of the applicable measured 3D points to the closest grid cell (e.g., pixel). Taking 3D points (e.g., 3D LiDAR points) with known or derivable (x, y, z) coordinates, each point may be projected onto the closest grid cell of the grid (e.g., pixel of the projection image 110) based on its (x, y) coordinates. Depending on the scenario, one measured 3D point, multiple measured 3D points, or zero measured 3D points may be mapped to any particular pixel (or cell) of the projection image 110. In some embodiments in which multiple measured 3D points land on a particular pixel (e.g., which may occur for pixels that represent locations that are relatively closer to a sensor), the projection module 240 may select the measured 3D point with the lowest height (or farthest range) to be represented by the pixel (e.g., and store that point's measured height or range value in the pixel). In some embodiments in which no measured 3D point lands on a particular pixel, the projection module 240 may assign that pixel a height or range value, a weighted height or range value, and/or a weight of zero. Additionally or alternatively, a local ground surface estimation map may be maintained over multiple time slices (e.g., projecting each point cloud into the map and filling in gaps in the map with measurements for newly observed areas). As such, in some embodiments in which no measured 3D point lands on a particular pixel, the projection module 240 may look up a corresponding portion of the local ground surface estimation map to determine whether the region corresponding to that particular pixel was previously observed, and if so, the projection module 240 may retrieve and store that value in the pixel. As such, the projection module 240 may generate a projection image 110 that represents measured values of an observed portion of a 3D environment (e.g., a measured height map, a measured range image).

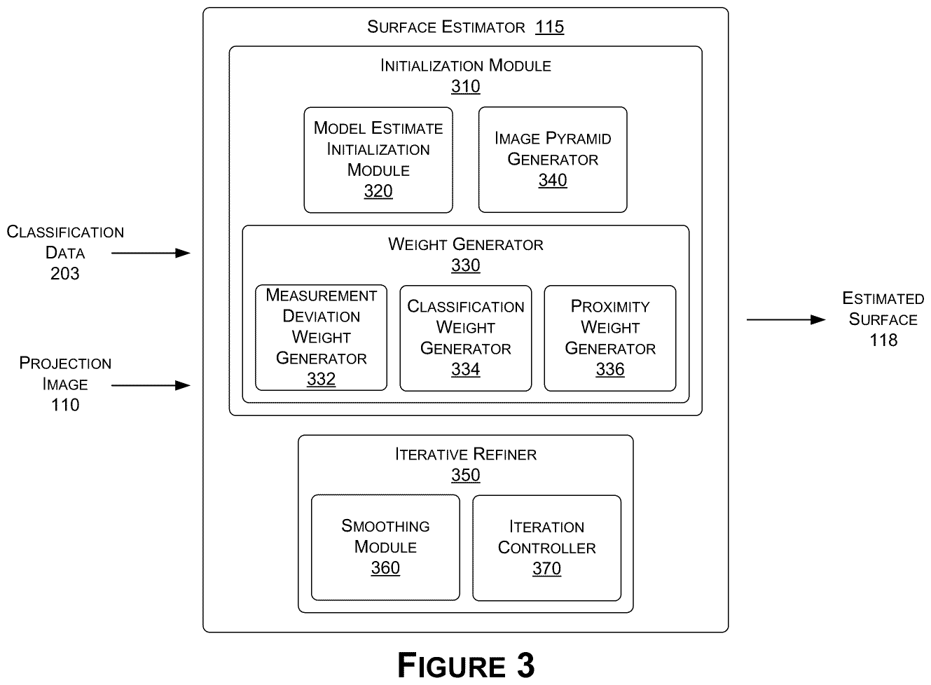

FIG. 3 is a diagram illustrating an example implementation of the surface estimator 115 of FIG. 1, in accordance with some embodiments of the present disclosure. In FIG. 3, the surface estimator 115 includes an initialization module 310 that initializes an estimated representation of an observed 3D surface structure (e.g., the estimated surface 118) and corresponding weights, and an iterative refiner 350 that smooths the estimated representation over any number of iterations. Generally, the estimated representation of the observed 3D surface structure (the estimated surface 118) may be understood as a grid of estimated surface values, an estimated surface map, and/or data representing an estimated surface a particular 2D view. In FIG. 2, the estimated representation of the observed 3D surface structure is referred to as the estimated surface 118.

At a high level, the initialization module 310 may initialize the estimated surface 118, and the iterative refiner 350 may iteratively smooth the estimated surface 118 by minimizing (or approximating minimization of) a cost function that penalizes deviation between measured values and estimated values and/or deviations among adjacent measured values. For example, the 3D structure of a ground surface may be modeled using a grid of cells (e.g., an image) where each cell (or pixel) stores an estimated surface value (e.g., estimated height of a point on the surface, range to a point on the surface). The initialization module 310 may initialize the estimated surface 118 by generating a grid (or map) of initialized estimated surface values and/or a corresponding grid (or map) of cell/pixel weights, and the iterative refiner 350 may iteratively smooth the grid of initialized estimated surface values (e.g., an estimated height map, an estimated range image) based on measured values represented in the projection image 110 and the grid of weights (e.g., a weight map).

In some embodiments, the surface estimator 115 determines estimated surface values (e.g., heights or ranges) that minimize (or approximate minimizing) a global cost function, such as:

$$C ( g ) = {\sum }_{p} {w}_{p} * data\_cost ( {h}_{p} - {g}_{p} ) + {w}_{s} * {\sum }_{p , q ϵ N} ‖ {g}_{p} - {g}_{q} ‖ , \qquad ( Eq . 1 )$$

where each cell or pixel p in the representation of the estimated surface is assigned a weight wₚ (e.g., a classification weight, a proximity weight) and a measurement deviation weight (e.g., represented by data cost) that penalizes deviation between measured values (e.g., measured height hₚ associated with cell or pixel p) and estimated values (e.g., estimated height gₚ associated with point p), and where each cell or pixel q in a neighborhood N of p is assigned a smoothness weight ifs that weights the difference between estimated values of the neighboring cells or pixels q and the estimated value of the cell or pixel p. In this example, the global cost function of equation 1 includes a measurement term that encourages estimated values to approximate the measured values, and a smoothness term that penalizes large variations in a local neighborhood, thereby encouraging smoothness. The use of a global cost function in an iterative approximation approach encourages propagation of current estimated values to a wide (e.g., global) neighborhood and helps to avoid getting stuck in local minima.

In some embodiments, the measurement term incorporates an asymmetric cost and/or weight function that defines a different measurement deviation weight for measurements that are above an estimated value (e.g., measured 3D points that are above an estimated surface) than for measurements that are below an estimated value (e.g., measured 3D points that are below the estimated surface). An asymmetric cost and/or weight function may be useful in various embodiments such as those that estimate a ground surface, as only a small fraction (e.g., <1%) of all measured 3D points may be assumed to lie significantly below the true ground surface (e.g., due to incorrect measurements or reflections).

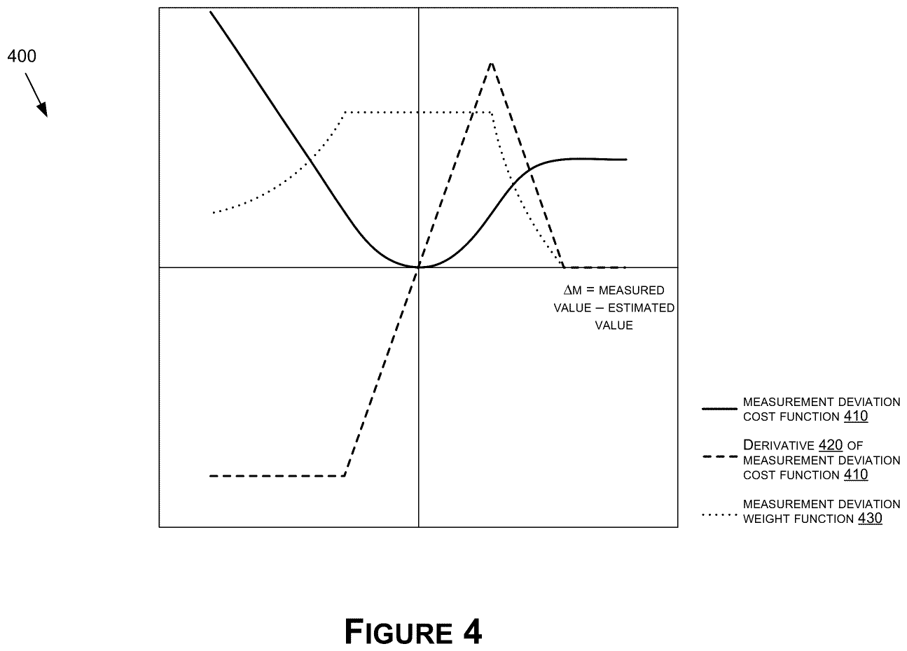

FIG. 4 is a diagram illustrating an example measurement deviation cost function 410 and an example measurement deviation weight function 430, in accordance with some embodiments of the present disclosure. In FIG. 4, the x-axis represents Δm—deviation between a measured value and a currently estimated value (e.g., for some embodiments that estimate surface height values, the difference between a measured height and the currently estimated height). For measured 3D points with a Δm smaller than zero (e.g., lying below the estimated ground surface), the measurement deviation cost function 410 may use Huber loss for a range of Δm (e.g., below a negative threshold Δm). For measured 3D points above that range and/or with a Δm greater than zero (e.g., lying above the estimated ground surface), the measurement deviation cost function 410 may use a quadratic function up to a cutoff distance (e.g., a positive threshold Δm) that then fades out to a constant, similar to a sub-linear Cauchy loss. This fading has the benefit that measured 3D points that are significantly higher than the cutoff distance (e.g., by some threshold) may be assigned a constant cost and a zero derivative, and therefore may avoid contributing to an estimated surface value when minimizing (or approximating minimization of) the cost function.

FIG. 4 illustrates an example (asymmetric) measurement deviation cost function 410, its derivative 420, and a corresponding measurement deviation weight function 430 defined (for at least a portion of the range of Δm) as the derivative 420 of the measurement deviation cost function 410 divided by Δm, and defining a fixed weight (e.g., 1) for a range of Δm where Δm is approximately zero. For example, in some embodiments where |positive threshold Δm|=|negative threshold Δm|=threshold, the measurement deviation cost function 410 may be defined as:

if Δm<−threshold→y=−2·threshold·(Δm)−threshold²

if |Δm|≤threshold→y=(Δm)²

if threshold<Δm≤2·threshold→y=4 [symbol] h [symbol] [symbol] [symbol] h [symbol] [symbol] [symbol] ·Δm−(Δm)²−2·

[symbol]

h [symbol] [symbol] [symbol] h [symbol] [symbol] [symbol] ²

if Δm>2·threshold→y=0 (Eqs. 2-5)

In some embodiments such as these, the cost assigned to measured 3D points that are clearly above the estimated ground surface remains constant, and the measurement deviation weight assigned to these points is zero, effectively deemphasizing measured 3D points that are clearly above the estimated ground surface.

As such and returning to FIG. 3, the initialization module 310 may initialize a representation of the estimated surface 118 (e.g., a grid of cells such as a top-down height map or a range image), and the iterative refiner 350 may iteratively smooth the estimated surface 118 by minimizing (or approximating minimization of) a cost function that penalizes deviation between measured values and estimated values and/or deviations among adjacent measured values, such as one or more of the functions defined by equations 1-5, above. In the example illustrated in FIG. 3, the initialization module 310 includes a model estimate initialization module 320, a weight generator 330, and an image pyramid generator 340. At a high level, the model estimate initialization module 320 initializes the estimated surface 118 (e.g., a grid of estimated surface values), the weight generator 330 initializes corresponding weights (e.g., a corresponding grid of weights), and the image pyramid generator 340 converts the estimated surface 118, the corresponding weights, and measured values (e.g., the projection image 110) into corresponding image pyramids with individual levels that may be used by the iterative refiner 350 to iteratively smooth the estimated surface 118.

Depending on the embodiment, the model estimate initialization module 320 may initialize the estimated surface 118 (e.g., a grid of estimated surface values), for example, using estimated based on a current ego-motion estimate, estimated values from a historic surface estimation (e.g., from a previous time slice), measured values represented in the projection image 110 (e.g., for the current time slice), Kalman filter estimates to provide estimates for previously unseen areas, and/or otherwise. For example, calibration data for a particular sensor may define or be used to determine that the particular sensor is installed at a fixed height above the ground. This known ground height may be assumed as an initial height or range value for a cell or pixel representing a point on the estimated ground surface (e.g., a point below the sensor, a point below the ego-machine) and/or for cells or pixels representing an area of the estimated ground surface (e.g., some or all of the area under the ego-machine, an area such as a radial area centered around a point below the sensor or the ego-machine). In some embodiments, the model estimate initialization module 320 may use the known ground height to set an initial height or range value for a cell or pixel representing a point on the estimated ground surface (e.g., a point below the sensor, a point below the ego-machine), define a plane that intersects that point and has a slant that matches the estimated surface normal represented by the direction of ego-motion of the ego-machine, and sample the plane to generate initial values for cells or pixels representing an area corresponding to the plane (e.g., representing an area within a radius of the ego-machine, such as a one or two meter radius).

Additionally or alternatively, the model estimate initialization module 320 (or some other component) may maintain a representation of historic surface estimations (e.g., in a local ground surface estimation map). As such, the model estimate initialization module 320 may identify an initial value for a particular cell or pixel (e.g., outside of the initialized region representing the vicinity of the ego-machine) by retrieving a historic estimated value for the 3D point represented by a particular cell or pixel. Additionally or alternatively, the model estimate initialization module 320 may identify an initial value for a particular cell or pixel (e.g., outside of the initialized region representing the vicinity of the ego-machine, for cells or pixels that do not have an associated historic estimated value) from a corresponding pixel of the projection image 110 (e.g., representing a measured 3D value from a current time slice). In some embodiments, remaining cells or pixels may be initialized with a value of zero.

In some embodiments, the weight generator 330 generates (e.g., a 2D representation of) weights for cells or pixels of the representation of the estimated surface 118 and/or the projection image 110. Generally, the 2D representation of weights may be understood as a grid of weights, a weight map, and/or data representing weights for associated cells or pixels of the representation of the estimated surface 118 and/or the projection image 110. For example, the estimated surface 118, the projection image 110, and the weights may each take the form of a 2D representation with corresponding dimensionality and aligned cells or pixels (and each may be represented as an image, a map, a grid, a layer, and/or some other structure). In some embodiments, for each for each cell (or pixel), the weight generator 330 may store a measurement deviation weight, a classification weight, a proximity weight, some combination thereof, and/or other weights. Accordingly, and depending on the embodiment, the weight generator 330 may include a measurement deviation weight generator 332, a classification weight generator 334, a proximity weight generator 336, and/or other components.

For example, in some embodiments that include a measurement deviation weight generator 332, the measurement deviation weight generator 332 determines a measurement deviation weight that penalizes cells (or pixels) associated with measured 3D values that deviate from a current (or initialized) estimated surface value. For example, measurement deviation weight generator 332 may determine a measurement deviation weight using the measurement deviation weight function 430 of FIG. 4, which may effectively deemphasize cells (or pixels) based on the deviation between their associated measured and estimated values (e.g., deviation between measured and estimated height or range).

In some embodiments, the classification weight generator 334 determines a classification weight based on a likelihood (e.g., represented as part of classification data 203) that the measured 3D point associated with a corresponding cell or pixel is part of the surface being estimated (e.g., a predicted confidence value, as described above). In some embodiments, the classification weight generator 334 applies a predicted confidence value for cells or pixels that carry measurements and a value of zero for cells or pixels that do not (e.g., no measured 3D value was projected onto those cells or pixels during projection).

In some embodiments, the proximity weight generator 336 assigns a proximity weight to cells or pixels based on proximity between the 3D point represented by a cell or pixel and the ego-machine (e.g., assign a higher weight to cells or pixels representing locations near the ego-machine such as locations within a meter or two radius).

As such, depending on the embodiment, the weight generator 330 may generate one or more weights for each cell or pixel, and may combine different types of weights into a composite weight (e.g., based on averaging, weighted averaging, multiplication, addition, etc.). In some embodiments, the weight generator 330 (or some other component) generates weighted values (e.g., a grid of weighted measured values, a weighted measured value map, data representing weighted depth data) by applying the measured values (e.g., measured height or range values) represented in the projection image 110 by corresponding weights (e.g., from the grid of weights).

In some embodiments that include an image pyramid generator 340, the image pyramid generator 340 convert a representation of each of the estimated surface 118 (e.g., the grid of estimated surface values), corresponding weights (e.g., the grid of weights), measured values (e.g., the projection image 110), and/or weighted measured values (e.g., the grid of weighted measured values) into a corresponding image pyramid that represents multiple levels of differing spatial resolutions. Taking an initialized grid of estimated surface values as an example, the image pyramid generator 340 may down-sample the grid of estimated surface values using any known technique (e.g., by averaging the values of cells in some neighborhood to derive a down-sampled value at the next level), and repeat the process to generate a plurality of levels representing successively down-sampled versions of the grid of estimated surface values.

As such, the iterative refiner 350 may applying smoothing to iteratively refine the estimated surface 118 (e.g., the grid of estimated surface values) based on the weighted measured values (e.g., the grid of weighted measured values) and/or the weights (e.g., the grid of weights). In some embodiments, this iterative estimation process employs a non-linear optimization scheme that iteratively updates estimated values (e.g., estimated height or range values) in the estimated surface 118. In the example illustrated in FIG. 3, the iterative refiner 350 includes a smoothing module 360 and an iteration controller 370.

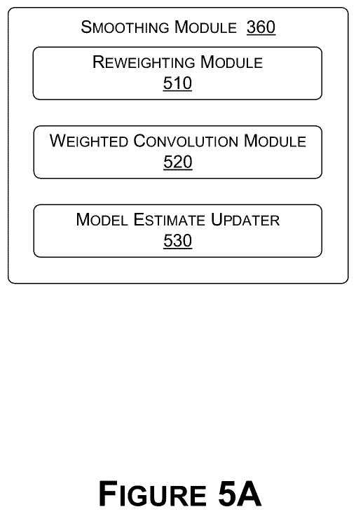

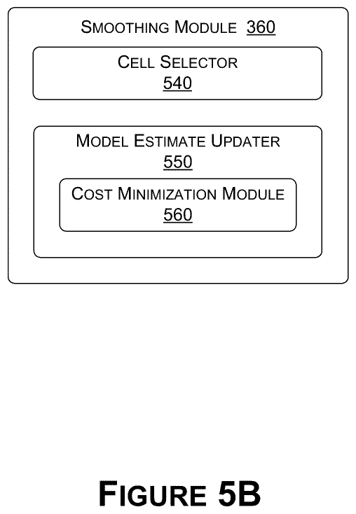

FIGS. 5A and 5B are diagrams illustrating example implementations of the smoothing module 360 of FIG. 3, in accordance with some embodiments of the present disclosure. FIG. 5A illustrates an example in which the smoothing module 360 applies a weighted convolution (e.g., Gaussian smoothing). More specifically, the smoothing module 360 of FIG. 5A includes a reweighting module 510, a weighted convolution module 520, and a model estimate updater 530. In this example, the weighted convolution module 520 may apply a weighted convolution to the grid of weighted measured values and/or the grid of weights, the model estimate updater 530 may generate updated estimated values with new estimated values that result from dividing each smoothed weighted measured value by its corresponding smoothed weight, and the reweighting module 510 may update the grid of weighted measured values and/or the grid of weights (e.g., in some embodiments that use a measurement deviation weight), for example, using the updated estimated values to update the measurement deviation weights and/or corresponding combined weights.

More specifically, in some embodiments, the weighted convolution module 520 applies a filtering operation performed on one or more (e.g., two) grids (e.g., the grid of measured values, the grid of weighted measured values, the grid of weights) using any suitable kernel (e.g., a Gaussian kernel). In an example implementation, the weighted convolution module 520 applies the filtering operation to the grid of measured values. Additionally or alternatively, the weighted convolution module 520 may apply the filtering operation to the grid of weighted measured values (e.g., weighted measured height values generated by multiplying the measured height for each cell by its corresponding weight) and/or applies the filtering operation to the grid of weights (e.g., the pure weights that are used to weight the measurements). After smoothing, the model estimate updater 530 may generate an updated estimated value (e.g., estimated height or range) for each cell by dividing the resulting smoothed weighted measured value (e.g., the smoothed weighted height, the smoothed weighted range) by its corresponding (e.g., smoothed) weight, effectively removing the weight normalization. This approach expands the area of influence (similar to the large receptive fields achievable in DNNs) and increases the robustness of the method by avoiding the entrapment of the solution in local minima. The window size of the used filter kernel may be any suitable size (e.g., 9×9), and the standard deviation (sigma) may lie in the range [1 . . . 3]. Consequently, each filter-based smoothing iteration may consider, e.g., the 80 neighbors in a local 9×9 window.

FIG. 5B illustrates an example in which the smoothing module 360 applies a red-black update scheme in which the smoothing module 360 generates updated estimated values for one set of non-adjacent cells (analogous to the white squares on a chess board), followed by updated estimated values for the other set of non-adjacent cells (analogous to the black squares on the chess board). In this example, the smoothing module 360 includes a cell selector 540 and a model estimate updater 550, which itself includes a cost minimization module 560. The cell selector 540 may identify a particular cell to update, iterating through the first set of non-adjacent cells (e.g., the white squares), then iterating through the second set of non-adjacent cells (e.g., the black squares). For any particular cell selected by the cell selector 540, the cost minimization module 560 of the model estimate updater 550 may compute an updated estimated value for the cell by minimizing a cost function, performing a weighted average of the measured values stored by its adjacent cells, and/or otherwise. Since the updated estimated value for a “red” cell depends on only adjacent “black” cells, and vice versa, this technique is highly parallelizable and reduces computation time over techniques.

More specifically, in some embodiments, for each cell in a grid of estimated surface values, the cost minimization module 560 may calculate and assign to the cell an updated estimated value (e.g., an updated estimated height or range value) that minimizes a cost function (e.g., an asymmetric cost function, a composition of cost functions). In an example embodiment, the cost minimization module 560 may minimize a cost function given by one or more of equations 1-5 above (or some other cost function that applies any or all of the types of weights described herein) and/or using a fixed smoothing weight to weight each of the adjacent cells, where the fixed smoothing weight may be selected to weight relative contributions of a measurement term and a smoothness term. In some embodiments in which the cost function is a composition of multiple cost functions (e.g., like the global cost function given by equation 1), the cost minimization module 560 may calculate an updated estimated value for a particular grid cell by evaluating each of the constituent cost functions separately (e.g., corresponding to the different ranges of Δm in the measurement deviation cost function 410 of FIG. 4) and identifying the candidate estimated value that minimizes a particular constituent cost function. As such, for a composition of four different cost functions, the cost minimization module 560 may identify four different candidate estimated values, calculate the corresponding cost of each candidate value, and select the candidate estimated value that produced the minimum cost to be the updated estimated value for that cell.

In some embodiments in which the cost function is a composition of multiple cost functions, instead of minimizing each of the costs functions, the cost minimization module 560 selects the one cost function that applies to the range of measurement deviations Δm that includes the current estimated value, and the cost minimization module 560 minimizes that cost function to calculate the updated estimated value for that cell.

In some embodiments, for any particular cell selected by the cell selector 540 (e.g., an interior cell having four adjacent cells that share an edge with the interior cell), the cost minimization module 560 computes an updated estimated value for the cell by performing a weighted average of the measured value represented by the selected cell (e.g., weighted by a corresponding weight from the grid of weights) and the measured values represented by its adjacent cells (e.g., weighted by a fixed smoothing weight for each of the adjacent cells). In some embodiments, adjacent cells are only included in the weighted average if they have an associated measurement (or if the cell is empty, a smoothness weight of zero may be applied).

Returning to FIG. 3, the iteration controller 370 may control the iterative process applied by the iterative refiner 350. Depending on the embodiment, the iteration controller 370 may run the iterative refiner 350 for a fixed number of iterations, or may terminate iterative refinement based on some termination criteria (e.g., maximum slant of an estimated ground surface is less than a known maximum slant from a local map, a particular slant of the estimated ground surface is less than an estimated surface normal corresponding to the ego-motion of the ego-machine, maximum number of iterations, goodness of fit, maximum local update less than a threshold). In some embodiments, the iteration controller 370 may skip updating regions where estimated heights have already converged (e.g., within a threshold) and proceed to updating the remaining areas.

In some embodiments in which the image pyramid generator 340 converts one or more of the grids into a corresponding a multi-level representation (e.g., an image pyramid), the iterative refiner 350 may initially apply smoothing to at coarsest level for any number of iterations. When the iteration controller 370 terminates smoothing at a particular level, the iterative refiner 350 (or some other component) may up-sample the smoothed and/or updated grids using any known technique to generate corresponding representations at the next level, and the iterative refiner 350 may apply smoothing at that level. As such, the process may be repeated, iteratively smoothing, then up-sampling at each successive level, for example, until completing iterative smoothing at the original resolution. In some embodiments that use a measurement deviation weight that relies on a composition of cost or weight functions separated at a threshold deviation (e.g., a threshold difference between measured and estimated height values), the threshold may be larger in upper pyramid levels to address the higher uncertainty of the solution in these levels.

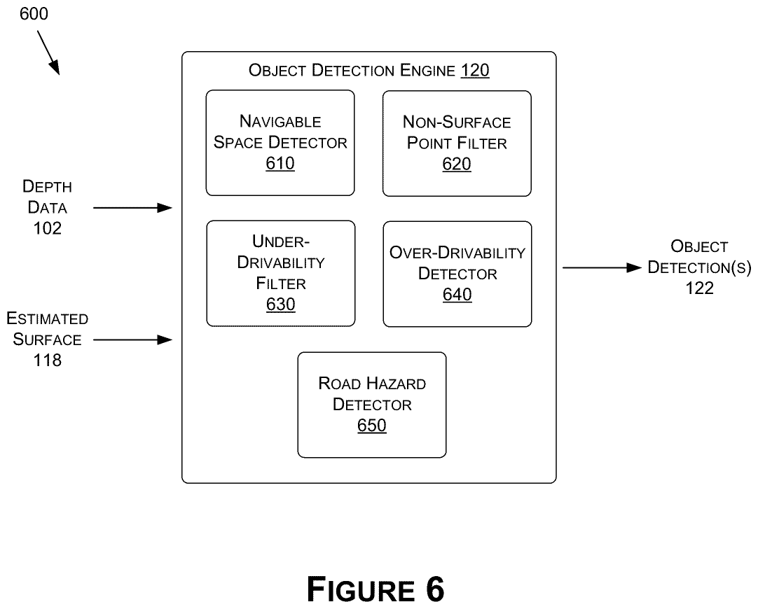

As such, and returning to FIG. 1, the surface estimator 115 may generate an estimated representation of an observed 3D surface structure (e.g., the estimated surface 118). In some embodiments, the object detection engine 120 may generate object detection(s) 122 based on the depth data 102 and/or the estimated surface 118. FIG. 6 is a diagram illustrating an example implementation of the object detection engine 120 of FIG. 1, in accordance with some embodiments of the present disclosure. In FIG. 6, the object detection engine 120 includes a navigable space detector 610, a non-surface point filter 620, an under-drivability filter 630, an over-drivability detector 640, and a road hazard detector 650.

In some embodiments, the estimated surface 118 may be used as, or a navigable space detector 610 may use the estimated surface 118 to derive, a 3D structure for a navigable space (e.g., a road). Generally, during the process of generating the estimated surface 118, some embodiments (e.g., of the projection module 240 of FIG. 2, of the classification weight generator 334 of FIG. 3) may have filtered out or de-emphasized points that were classified as not being part of a navigable space, so in some embodiments, the resulting estimated surface 118 may be assumed to be an estimation of the navigable space.

Additionally or alternatively, free space estimation may be applied to a captured image to detect pixels that belong to a navigable space (e.g., drivable free-space), the navigable space detector 610 may map cells or pixels that were classified as being part of the navigable space to corresponding measured 3D locations (e.g., by backprojecting pixels from the image into a 3D representation of the environment), and the navigable space detector 610 may select 3D points on the estimated surface 118 that fall within some threshold distance (e.g., threshold height or range) of the 3D locations that were classified as part of the navigable space (and the others 3D points may be filtered out). As such, 3D points of the estimated surface 118 may be determined to belong to a navigable space (e.g., drivable free-space), for example, based on each 3D point falling within some threshold distance to a classified 3D point.

Accordingly, the navigable space detector 610 may use the 3D points determined to be part of the navigable space (e.g., the road) to generate any suitable representation of the 3D surface structure of the navigable space, such as a 3D point cloud. As such, the techniques described herein may be used to observe and reconstruct a representation of a navigable space (e.g., drivable free-space), such as a 3D road surface, and the representation of the navigable space (and/or corresponding confidence values) may be provided to the autonomous driving software stack 124 to enable safe and comfortable planning and control of the autonomous vehicle.

In some embodiments, a non-surface point filter 620 may identify and filter out measured 3D (e.g., LiDAR) points that are represented in the depth data 102, and the remaining measured 3D points may be classified using any known technique to detect obstacles and/or other objects represented by the measured 3D points.

For example, in some embodiments, an under-drivability filter 630 may determine that (e.g., remaining) measured 3D points represented in the depth data 102 belong to an object that is sufficiently high above the estimated surface 118 such that the ego-machine may safely navigate under the object. More specifically, the under-drivability filter 630 may classify measured 3D points that are greater than (or equal) some threshold height above the estimated surface 118 as object detection(s) 122 representing an object(s) that the ego-machine may safely pass under. In some embodiments, measured 3D points that are (at or) above the threshold height above the estimated ground surface may be removed from subsequent processing and/or disregarded from further object detection analysis.

In some embodiments, an over-drivability detector 640 may determine that (e.g., remaining) measured 3D points represented in the depth data 102 belong to an object that is sufficiently low on the estimated surface 118 such that the ego-machine may safely navigate over the object. More specifically, in some embodiments, the over-drivability detector 640 may classify measured 3D points that are determined not to be part of the estimated surface 118 as part of a road hazard or obstacle, and the over-drivability detector 640 may estimate its height by comparison to the estimated surface 118. The over-drivability detector 640 may classify measured 3D points that are less than (or equal to) some threshold height above the estimated surface 118 and/or (equal to or) smaller than some threshold size as object detection(s) 122 representing a small object(s) that can be safely driven over.

In some embodiments (e.g., that filter out or classify measured 3D points that belong to a navigable space, measured 3D points that may be safely driven under, and/or measured 3D points that may be safely driven under), a road hazard detector 650 may classify remaining 3D points as object detection(s) 122 representing obstacles (e.g., objects that are on or sticking out of the ground surface, suspended objects that the ego-machine cannot safely pass under) that may need avoidance regardless of class type (e.g., avoid all remaining objects, avoid objects larger than a designated size). As such, the road hazard detector 650 may provide the object detection(s) 122 the autonomous driving software stack 124 to enable safe and comfortable planning and control of the autonomous vehicle.

As such and returning to FIG. 1, once the 3D structure of the estimated surface 118 and/or the object detection(s) 122 have been determined, positional values that are not already in 3D world coordinates may be converted to 3D world coordinates, associated with a corresponding class label identifying the estimated surface 118 (e.g., a road) and/or the object detection(s) 122, and/or may be provided for use by the vehicle 1000 of FIGS. 10A-10D in performing one or more operations. For example, a representation of the estimated surface 118 and/or the object detection(s) 122 (e.g., a 3D point cloud, a 2D representation such as a projection image, corresponding labels, corresponding weights which may be interpreted as confidence values, etc.) may be used by control component(s) of the vehicle 1000, such as an autonomous driving software stack 124 executing on one or more components of the vehicle 1000 of FIGS. 10A-10D (e.g., the SoC(s) 1704, the CPU(s) 1718, the GPU(s) 1720, etc.). For example, the vehicle 1000 may use this information (e.g., instances of obstacles) to navigate, plan, or otherwise perform one or more operations (e.g., obstacle or protuberance avoidance, lane keeping, lane changing, merging, splitting, adapting a suspension system of the ego-machine to match the current road surface, applying an early acceleration or deceleration based on an approaching surface slope, mapping, etc.) within the environment.

In some embodiments, the estimated surface 118 and/or the object detection(s) 122 may be used by one or more layers of the autonomous driving software stack 124 (alternatively referred to herein as “drive stack 124”). The drive stack 124 may include a sensor manager (not shown), perception component(s) (e.g., corresponding to a perception layer of the drive stack 124), a world model manager 126, planning component(s) 128 (e.g., corresponding to a planning layer of the drive stack 124), control component(s) 130 (e.g., corresponding to a control layer of the drive stack 124), obstacle avoidance component(s) 132 (e.g., corresponding to an obstacle, or collision avoidance layer of the drive stack 124), actuation component(s) 134 (e.g., corresponding to an actuation layer of the drive stack 124), and/or other components corresponding to additional and/or alternative layers of the drive stack 124. The surface estimation pipeline 100 may, in some examples, be executed at least in part by the perception component(s), which may feed up the layers of the drive stack 124 to the world model manager, as described in more detail herein.

The sensor manager may manage and/or abstract sensor data from the sensors of the vehicle 1000. For example, and with reference to FIG. 10C, the sensor data may be generated (e.g., perpetually, at intervals, based on certain conditions) by the LIDAR sensor(s) 1064, the RADAR sensor(s) 1060, the ultrasonic sensor(s) 1062, the stereo camera(s) 1068, other camera(s), and/or other sensors). The sensor manager may receive the sensor data from the sensors in different formats (e.g., sensors of the same type may output sensor data in different formats), and may be configured to convert the different formats to a uniform format (e.g., for each sensor of the same type). As a result, other components, features, and/or functionality of the autonomous vehicle 1000 may use the uniform format, thereby simplifying processing of the sensor data. In some examples, the sensor manager may use a uniform format to apply control back to the sensors of the vehicle 1000, such as to set frame rates or to perform gain control. The sensor manager may also update sensor packets or communications corresponding to the sensor data with timestamps to help inform processing of the sensor data by various components, features, and functionality of an autonomous vehicle control system.

A world model manager 126 may be used to generate, update, and/or define a world model. The world model manager 126 may use information generated by and received from the perception component(s) of the drive stack 124 (e.g., the locations of detected obstacles). The perception component(s) may include an obstacle perceiver, a path perceiver, a wait perceiver, a map perceiver, and/or other perception component(s). For example, the world model may be defined, at least in part, based on affordances for obstacles, paths, and wait conditions that can be perceived in real-time or near real-time by the obstacle perceiver, the path perceiver, the wait perceiver, and/or the map perceiver. The world model manager 126 may continually update the world model based on newly generated and/or received inputs (e.g., data) from the obstacle perceiver, the path perceiver, the wait perceiver, the map perceiver, and/or other components of the autonomous vehicle control system.

The world model may be used to help inform planning component(s) 128, control component(s) 130, obstacle avoidance component(s) 132, and/or actuation component(s) 134 of the drive stack 124. The obstacle perceiver may perform obstacle perception that may be based on where the vehicle 1000 is allowed to drive or is capable of driving (e.g., based on the location of the drivable or other navigable paths defined by avoiding detected obstacles in the environment and/or detected protuberances in the road surface), and how fast the vehicle 1000 can drive without colliding with an obstacle (e.g., an object, such as a structure, entity, vehicle, etc.) that is sensed by the sensors of the vehicle 1000.

The path perceiver may perform path perception, such as by perceiving nominal paths that are available in a particular situation. In some examples, the path perceiver may further take into account lane changes for path perception. A lane graph may represent the path or paths available to the vehicle 1000, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information. In some embodiments, the path perceiver may take into account the estimated surface 118 and/or the object detection(s) 122. For example, the path perceiver may evaluate a reconstructed 3D road surface to identify protuberances and include paths that avoid the protuberances.

The wait perceiver may be responsible to determining constraints on the vehicle 1000 as a result of rules, conventions, and/or practical considerations. For example, the rules, conventions, and/or practical considerations may be in relation to a 3D road surface, traffic lights, multi-way stops, yields, merges, toll booths, gates, police or other emergency personnel, road workers, stopped buses or other vehicles, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver. In some embodiments, the wait perceiver may take into account the estimated surface 118 and/or the object detection(s) 122. For example, the wait perceiver may evaluate a reconstructed 3D road surface to identify an approaching surface slope and determine to apply and/or apply an early acceleration or deceleration to accommodate the approaching surface slope. Additionally or alternatively, the wait perceiver may evaluate a reconstructed 3D road surface to identify a portion of an approaching road surface and determine to adapt and/or adapt a suspension system of the vehicle 1000 such that, once the vehicle 1000 reaches a corresponding portion of the road, the suspension system matches the identified road surface.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 1000 of static or stationary infrastructure objects and obstacles. The map perceiver may also generate information for the wait perceiver and/or the path perceiver, for example, such as to determine which light at an intersection has to be green for the vehicle 1000 to take a particular path.

In some examples, information from the map perceiver may be sent, transmitted, and/or provided to server(s) (e.g., to a map manager of server(s) 1078 of FIG. 10D), and information from the server(s) may be sent, transmitted, and/or provided to the map perceiver and/or a localization manager of the vehicle 1000. The map manager may include a cloud mapping application that is remotely located from the vehicle 1000 and accessible by the vehicle 1000 over one or more network(s). For example, the map perceiver and/or the localization manager of the vehicle 1000 may communicate with the map manager and/or one or more other components or features of the server(s) to inform the map perceiver and/or the localization manager of past and present drives or trips of the vehicle 1000, as well as past and present drives or trips of other vehicles. The map manager may provide mapping outputs (e.g., map data) that may be localized by the localization manager based on a particular location of the vehicle 1000, and the localized mapping outputs may be used by the world model manager 126 to generate and/or update the world model.

The planning component(s) 128 may include a route planner, a lane planner, a behavior planner, and a behavior selector, among other components, features, and/or functionality. The route planner may use the information from the map perceiver, the map manager, and/or the localization manger, among other information, to generate a planned path that may consist of GNSS waypoints (e.g., GPS waypoints), 3D world coordinates (e.g., Cartesian, polar, etc.) that indicate coordinates relative to an origin point on the vehicle 1000, etc. The waypoints may be representative of a specific distance into the future for the vehicle 1000, such as a number of city blocks, a number of kilometers, a number of feet, a number of inches, a number of miles, etc., that may be used as a target for the lane planner.

The lane planner may use the lane graph (e.g., the lane graph from the path perceiver), object poses within the lane graph (e.g., according to the localization manager), and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The behavior planner may determine the feasibility of basic behaviors of the vehicle 1000, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) 130 may follow a trajectory or path (lateral and longitudinal) that has been received from the behavior selector (e.g., based on the estimated surface 118 and/or the object detection(s) 122) of the planning component(s) 128 as closely as possible and within the capabilities of the vehicle 1000. The control component(s) 130 may use tight feedback to handle unplanned events or behaviors that are not modeled and/or anything that causes discrepancies from the ideal (e.g., unexpected delay). In some examples, the control component(s) 130 may use a forward prediction model that takes control as an input variable, and produces predictions that may be compared with the desired state (e.g., compared with the desired lateral and longitudinal path requested by the planning component(s) 128). The control(s) that minimize discrepancy may be determined.

Although the planning component(s) 128 and the control component(s) 130 are illustrated separately, this is not intended to be limiting. For example, in some embodiments, the delineation between the planning component(s) 128 and the control component(s) 130 may not be precisely defined. As such, at least some of the components, features, and/or functionality attributed to the planning component(s) 128 may be associated with the control component(s) 130, and vice versa. This may also hold true for any of the separately illustrated components of the drive stack 124.

The obstacle avoidance component(s) 132 may aid the autonomous vehicle 1000 in avoiding collisions with objects (e.g., moving and stationary objects). The obstacle avoidance component(s) 132 may include a computational mechanism at a “primal level” of obstacle avoidance, and may act as a “survival brain” or “reptile brain” for the vehicle 1000. In some examples, the obstacle avoidance component(s) 132 may be used independently of components, features, and/or functionality of the vehicle 1000 that is required to obey traffic rules and drive courteously. In such examples, the obstacle avoidance component(s) may ignore traffic laws, rules of the road, and courteous driving norms in order to ensure that collisions do not occur between the vehicle 1000 and any objects. As such, the obstacle avoidance layer may be a separate layer from the rules of the road layer, and the obstacle avoidance layer may ensure that the vehicle 1000 is only performing safe actions from an obstacle avoidance standpoint. The rules of the road layer, on the other hand, may ensure that vehicle obeys traffic laws and conventions, and observes lawful and conventional right of way (as described herein).

In some examples, the drivable or other navigable paths and/or the estimated surface 118 and/or the object detection(s) 122 may be used by the obstacle avoidance component(s) 132 in determining controls or actions to take. For example, the drivable paths may provide an indication to the obstacle avoidance component(s) 132 of where the vehicle 1000 may maneuver without striking any objects, protuberances, structures, and/or the like, or at least where no static structures may exist.

In non-limiting embodiments, the obstacle avoidance component(s) 132 may be implemented as a separate, discrete feature of the vehicle 1000. For example, the obstacle avoidance component(s) 132 may operate separately (e.g., in parallel with, prior to, and/or after) the planning layer, the control layer, the actuation layer, and/or other layers of the drive stack 124.

As such, the vehicle 1000 may use this information (e.g., as the edges, or rails of the paths) to navigate, plan, or otherwise perform one or more operations (e.g. lane keeping, lane changing, merging, splitting, etc.) within the environment.

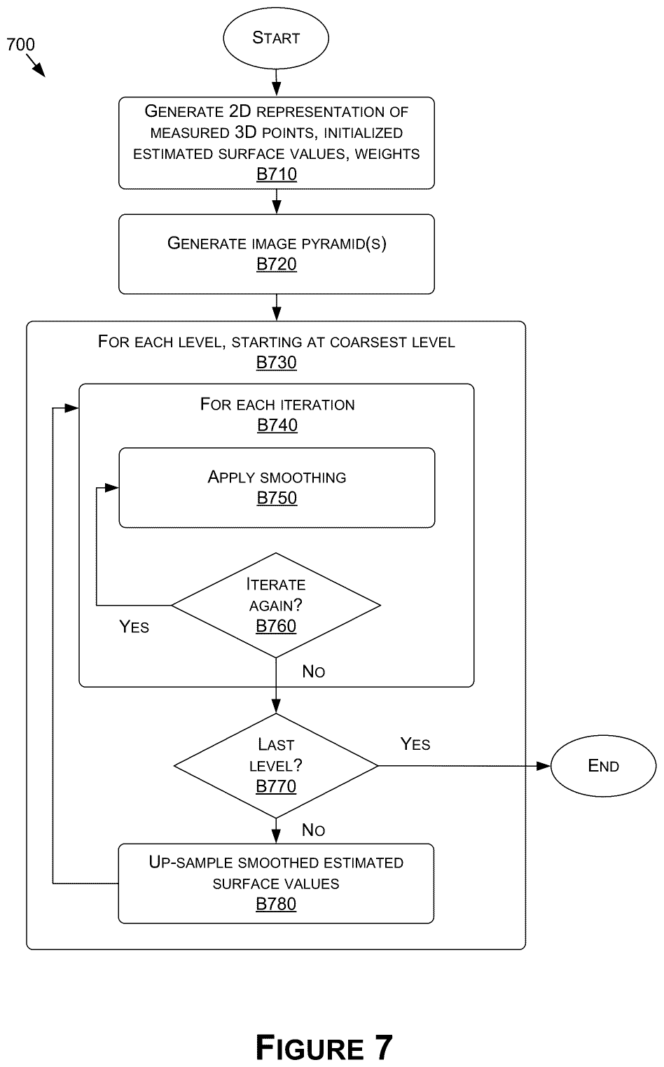

Now referring to FIGS. 7-9, each block of methods 700-900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 700-900 are described, by way of example, with respect to the surface estimation pipeline 100 of FIG. 1. However, these methods may additionally or alternatively be executed by any one system, or any combination of systems, including, but not limited to, those described herein.

FIG. 7 is a flow diagram showing a method 700 for iteratively refining an estimated surface, in accordance with some embodiments of the present disclosure. The method 700, at block B710, includes generating a 2D representation of measured 3D points, initialized estimated surface values, and weights. For example, with respect to FIG. 1, the input generator 105 may process the depth data 102 to generate a representation of an observed portion of a 3D environment (e.g., the projection image 110), which may comprise a projected 2D representation of measured 3D points on a 3D surface structure of interest (e.g., a projected 3D point cloud). With respect to FIG. 3, the model estimate initialization module 320 may initialize the estimated surface 118 (e.g., a grid of estimated surface values), and the weight generator 330 may initialize corresponding weights (e.g., a corresponding grid of weights).

The method 700, at optional block B720, includes generating image pyramids for the measured 3D points, the initialized estimated surface values, and the weights. For example, with respect to FIG. 3, the image pyramid generator 340 may convert a representation of each of the estimated surface 118 (e.g., a grid of estimated surface values), corresponding weights (e.g., the grid of weights), measured values (e.g., the projection image 110), and/or weighted measured values (e.g., the grid of weighted measured values) into a corresponding image pyramid that represents multiple levels of differing spatial resolutions.

In some embodiments that include optional block B720, the method 700, at block B730, represents an iterative process that applies smoothing to the estimated surface values at each level of the image pyramid(s), starting at the coarsest level. In some embodiments that do not include optional block B720, the method 700 advances from block B710 to block B740.

The method 700, at block B740, represents an iterative process that applies smoothing to the estimated surface values (e.g., at a particular level of the image pyramid(s)). At each iteration, the method 700 at block B750 includes applying smoothing, and at block B760, determines whether to iterate again.

In an example of smoothing, with respect to FIG. 3, the iterative refiner 350 may applying smoothing to iteratively refine the estimated surface 118 (e.g., the grid of estimated surface values) based on the weighted measured values (e.g., the grid of weighted measured values) and/or the weights (e.g., the grid of weights). For example, with respect to FIG. 5A, the weighted convolution module 520 may apply a weighted convolution to the grid of weighted measured values and/or the grid of weights, the model estimate updater 530 may generate updated estimated values with new estimated values that result from dividing each smoothed weighted measured value by its corresponding smoothed weight, and the reweighting module 510 may update the grid of weighted measured values and/or the grid of weights (e.g., in some embodiments that use a measurement deviation weight), for example, using the updated estimated values to update the measurement deviation weights and/or corresponding combined weights.

In another example of smoothing, with respect to FIG. 5B, the smoothing module 360 may apply a red-black update scheme in which the smoothing module 360 generates updated estimated values for one set of non-adjacent cells (analogous to the white squares on a chess board), followed by updated estimated values for the other set of non-adjacent cells (analogous to the black squares on the chess board). For any particular cell selected by the cell selector 540, the cost minimization module 560 of the model estimate updater 550 may compute an updated estimated value for the cell by minimizing a cost function, performing a weighted average of the measured values stored by its adjacent cells, and/or otherwise.

The method, at block B760, involves a determination of whether or not to apply another iteration of the smoothing at block B750. For example, with respect to FIG. 3, the iteration controller 370 may run the iterative refiner 350 for a fixed number of iterations, or may terminate iterative refinement based on some termination criteria (e.g., maximum slant of an estimated ground surface is less than a known maximum slant from a local map, a particular slant of the estimated ground surface is less than an estimated surface normal corresponding to the ego-motion of the ego-machine, maximum number of iterations, goodness of fit, maximum local update less than a threshold). If a determination is made to iterate again, the method 700 returns to block B750 to apply another iteration of smoothing. If a determination is made not to iterate again, the method 700 advances to block B770 (e.g., in some embodiments that include optional blocks B720), or terminates (e.g., in some embodiments that do not include optional block B720).

The method, at block B770, includes determining whether the final level of the image pyramid(s) have been smoothed. If it has, the method 700 terminates. Otherwise, the method 700 advances to block B780, which includes up-sampling the smoothed estimated surface values (and/or other smoothed representations from a particular level, such as smoothed weighted measured 3D points, smoothed weights). After up-sampling to generate smoothed representations at the next pyramid level, the method 700 returns to block B740 to begin iterative smoothing at that level, repeating the iterative smoothing process for each remaining level of the image pyramid(s). For example, with respect to FIG. 3, the iterative refiner 350 may initially apply smoothing to at coarsest level for any number of iterations. When the iteration controller 370 terminates smoothing at a particular level, the iterative refiner 350 (or some other component) may up-sample the smoothed and/or updated grids using any known technique to generate corresponding representations at the next level, and the iterative refiner 350 may apply smoothing at that level. As such, the process may be repeated, iteratively smoothing and then up-sampling at each successive level, for example, until completing iterative smoothing at the original resolution.

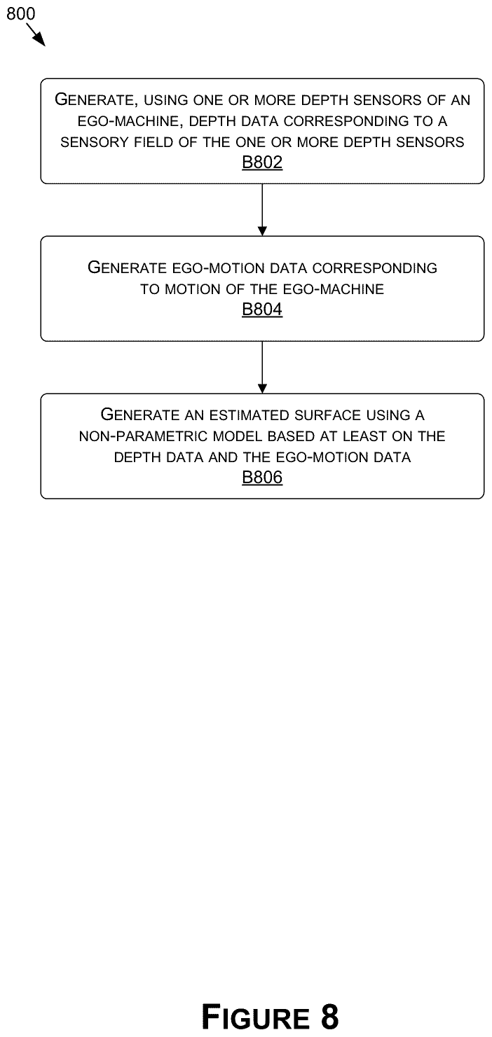

FIG. 8 is a flow diagram showing a method 800 for generating an estimated surface using a non-parametric model, in accordance with some embodiments of the present disclosure. The method 800, at block B802, includes generating, using one or more depth sensors of an ego-machine, depth data corresponding to a sensory field of the one or more depth sensors. For example, with respect to FIG. 1, the depth data 102 may be captured by one or more depth sensor(s) 101 of an ego-machine (e.g., the vehicle 1000 of FIGS. 10A-10D) as the ego-machine navigates through the 3D environment.

The method 800, at block B804, includes generating ego-motion data corresponding to motion of the ego-machine. Ego-motion may be estimated using any known technique, and may include data representative of location, heading, speed, and/or pose of the ego-machine (e.g., a 6 DOF ego-motion estimate).

The method 800, at block B806, includes generating an estimated surface using a non-parametric model based at least on the depth data and the ego-motion data. In some embodiments, ego-motion data may be used to accumulate depth data. For example, with respect to FIG. 1, the input generator 105 may accumulate and/or ego-motion compensate the depth data 102 over multiple time slices (e.g., multiple LiDAR spins) and project the accumulated and/or ego-motion compensated depth data into the projection image 110, and the surface estimator 115 may generate and iteratively refine an estimated representation of the observed 3D surface structure (e.g., the estimated surface 118) based on measured 3D points from a current time slice (e.g., the projection image 110), measured 3D points from a previous time slice, and/or other factors.

Additionally or alternatively, ego-motion data may be used to initialize estimated surface values. For example, with respect to FIG. 3, calibration data for a particular sensor may define or be used to determine that the particular sensor is installed at a fixed height above the ground. The model estimate initialization module 320 may initialize the estimated surface 118 (e.g., a grid of estimated surface values) using the fixed ground height to set an initial height or range value for a cell or pixel representing a point on the estimated ground surface (e.g., a point below the sensor, a point below the ego-machine), define a plane that intersects that point and has a slant that matches the estimated surface normal represented by the direction of ego-motion of the ego-machine, and sample the plane to generate initial values for cells or pixels representing an area corresponding to the plane (e.g., representing an area within a radius of the ego-machine, such as a one or two meter radius).

Additionally or alternatively, ego-motion data may be used to determine when to terminate iterative smoothing of the estimated surface. For example, with respect to FIG. 3, the iteration controller 370 may terminate iterative refinement based on a determination that a particular slant of the estimated ground surface is less than an estimated surface normal corresponding to the ego-motion of the ego-machine.

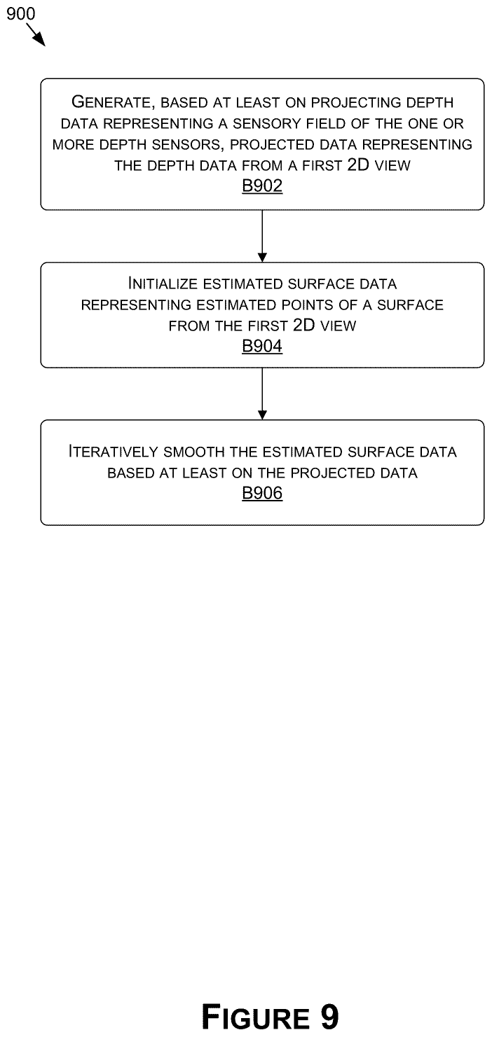

FIG. 9 is a flow diagram showing a method 900 for iteratively smoothing estimated surface data, in accordance with some embodiments of the present disclosure. The method 900, at block B902, includes generating, based at least on projecting depth data representing a sensory field of the one or more depth sensors, projected data representing the depth data from a first 2D view. For example, with respect to FIG. 1, the input generator 105 may process the depth data 102 to generate a representation of an observed portion of the 3D environment (e.g., a projection image 110), which may comprise a projected 2D representation of measured 3D points on a 3D surface structure of interest (e.g., a projected 3D point cloud).

The method 900, at block B904, includes initializing estimated surface data representing estimated points of a surface from the first 2D view. For example, with respect to FIG. 3, the model estimate initialization module 320 may initialize the estimated surface 118 (e.g., a grid of estimated surface values), for example, using estimated based on a current ego-motion estimate, estimated values from a historic surface estimation (e.g., from a previous time slice), measured values represented in the projection image 110 (e.g., for the current time slice), and/or otherwise.

The method 900, at block B906, includes iteratively smoothing the estimated surface data based at least on the projected data. For example, with respect to FIG. 3, the iterative refiner 350 may iteratively smooth the estimated surface 118 by minimizing (or approximating minimization of) a cost function that penalizes deviation between measured values and estimated values. For example, the iterative refiner 350 may applying smoothing to iteratively refine the estimated surface 118 (e.g., a grid of estimated surface values) based on measured values (e.g., a grid of measured values), weighted measured values (e.g., a grid of weighted measured values) and/or weights (e.g., a grid of weights). With respect to FIG. 5A, the smoothing module 360 may apply smoothing by sliding a (e.g., Gaussian) kernel across a grid (e.g., of measured values, weighted measured values, weights), and may generate an updated estimated value (e.g., estimated height or range) for each cell by looking up a resulting smoothed measured value (e.g., smoothed height, smoothed range), dividing a resulting smoothed weighted measured value by its corresponding (e.g., smoothed) weight (effectively removing the weight normalization), and/or otherwise. With respect to FIG. 5B, the smoothing module 360 may apply a red-black update scheme to update estimated surface values, where the estimated surface value for each cell may be computed by minimizing a cost function that penalizes deviation between measured values and estimated values, performing a weighted average of the measured values of its adjacent cells, and/or otherwise.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMD display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HID map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

Example Data Center

FIG. 12 illustrates an example data center 1200 that may be used in at least one embodiments of the present disclosure (e.g., for remotely executing any of the components described herein). The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating, using one or more depth sensors of an ego-machine, depth data corresponding to one or more sensory fields of the one or more depth sensors;
generating ego-motion data corresponding to motion of the ego-machine; and
generating an estimated surface using a non-parametric model based at least on the depth data and the ego-motion data.

2. The method of claim 1, further comprising:
converting, based at least in part on calibration data corresponding to the one or more depth sensors, one or more point clouds represented by the depth data from a first coordinate system of the one or more depth sensors to a second coordinate system of the ego-machine;
wherein the estimating the surface is based at least on the one or more point clouds after the converting.

3. The method of claim 1, wherein the estimating the surface using the non-parametric model comprises smoothing the estimated surface over one or more iterations.

4. The method of claim 3, wherein the smoothing comprises, at individual iterations of the one or more iterations, updating one or more weights associated with one or more points of one or more point clouds corresponding to the depth data.

5. The method of claim 4, wherein the estimating the surface further comprises initializing the one or more weights.

6. The method of claim 4, further comprising detecting one or more obstacles using the estimated surface based at least in part on determining a subset of the one or more points having associated heights that are greater than a threshold height above the estimated surface.

7. The method of claim 6, wherein the associated heights correspond to relative heights with respect to the estimated surface.

8. The method of claim 3, wherein at a first set of iterations the smoothing is applied at a first spatial resolution and at a second set of iterations the smoothing is applied at a second spatial resolution that is greater than the first spatial resolution.

9. The method of claim 1, wherein the non-parametric model represents the estimated surface using a grid of equally sized cells.

10. The method of claim 1, further comprising:
generating, using a deep neural network (DNN), data representative of a semantic segmentation map;
comparing one or more points of one or more point clouds represented by the depth data to corresponding locations in the semantic segmentation map;
determining, based at least in part on the comparing, a subset of the one or more points identified as corresponding to one or more objects; and
performing object detection using the subset of the one or more points.

11. A processor comprising:
one or more processing units to generate an estimated surface using a non-parametric model and based at least on one or more point clouds and motion of an ego-machine over time.

12. The processor of claim 11, where the one or more processing units are further to generate the estimated surface over a plurality of iterations, at least, by smoothing the estimated surface at individual iterations of the plurality of iterations.

13. The processor of claim 12, wherein the smoothing comprises evaluating a global cost function that penalizes deviations in height or range between points of the one or more point clouds and corresponding points of the estimated surface.

14. The processor of claim 12, wherein the one or more processing units are further to apply the smoothing at a first spatial resolution during a first set of iterations of the plurality of iterations, and at a second spatial resolution during a second set of iterations of the plurality of iterations, the first spatial resolution being different from the second spatial resolution.

15. The processor of claim 11, wherein the non-parametric model models the estimated surface as a grid of cells.

16. The processor of claim 15, wherein the one or more processing units are further to perform object detection using the estimated surface, at least, by determining one or more points of the one or more point clouds associated with height values greater than a threshold height relative to the estimated surface.

17. The processor of claim 11, wherein the one or more processing units are further to use calibration data corresponding to one or more depth sensors that generate data representative of the one or more points clouds to convert the one or more point clouds from a coordinate system of the one or more depth sensors to a coordinate system of the ego-machine.

18. The processor of claim 11, wherein the one or more point clouds include a first point cloud corresponding to a first time and a second point cloud corresponding to a second time prior to the first time, wherein the one or more processing units are further to convert the second point cloud to a coordinate system of the first point cloud using the motion of the ego-machine between the second time and the first time.

19. The processor of claim 11, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

20. A system comprising:
one or more processing units to:
generate, using one or more depth sensors of an ego-machine, depth data corresponding to one or more sensory fields of the one or more depth sensors;
generate ego-motion data corresponding to motion of the ego-machine; and
generate an estimated surface using a non-parametric model based at least on the depth data and the ego-motion data.
